(19) United States
(12) Patent Application Publication
(10) Pub. No.: US 2026/0344672 A1
(43) Pub. Date: Nov. 5, 2026

(54) CROP ENHANCEMENT

(71) Applicant: SYNGENTA CROP PROTECTION AG, Basel (CH)

(72) Inventors: Allen TERRY, South Calgary, Alberta (CA); Shad MILLIGAN, South Calgary, Alberta (CA); Karen ULLMAN, South Calgary, Alberta (CA)

(73) Assignee: SYNGENTA CROP PROTECTION AG, Basel (CH)

(21) Appl. No.: 19/488,505

(22) PCT Filed: May 27, 2024
(86) PCT No.: PCT/EP2024/064549

§ 371 Date: Nov. 26, 2025

(30) Foreign Application Priority Data
May 31, 2023 (EP) 23176373.1

(51) Int. Cl. A01N 43/88; A01N 37/26; A01N 43/36; A01N 43/56; A01N 43/653; A01N 43/80; A01P 7/04

(52) U.S. Cl. CPC A01N 43/88; A01N 37/26; A01N 43/36; A01N 43/56; A01N 43/653; A01N 43/80; A01P 7/04

(57) ABSTRACT

The present invention relates to a method of enhancing a crop by applying to a plant propagation material or a plant growing locus, a pesticidal combination comprising at least isocycloseram as active ingredient (I) and thiamethoxam as active ingredient (II), in any desired sequence or simultaneously.

The present invention relates to a method of crop enhancement, in particular to a method of enhancing crop plants by applying to a plant propagation material or a plant growing locus, a pesticidal combination comprising at least isocycloseram and thiamethoxam, as active ingredients, and to the use of said pesticidal combination for enhancing crops.

Certain methods of crop enhancement are described in the literature. These methods are usually based on conventional fertilising but some also rely on chemicals originally developed for other uses, for example, the insecticide fipronil has been reported e.g. to enhance overall root system and root hair development, increase tiller number and productivity, increase photosynthetic capacity (plant greenness), increase leaf area and plant height and stimulate early flowering and grain maturation and the fungicide pyraclostrobin has been reported to improve plant health e.g. to improve the tolerance to environmental stresses.

To this end, a first aspect of the present invention relates to a method of enhancing a crop by applying to a plant propagation material or a plant growing locus, a pesticidal combination comprising at least isocycloseram as active ingredient (I) and thiamethoxam as active ingredient (II), in any desired sequence or simultaneously.

According to the present invention, ‘crop enhancement’ or ‘enhancing crops’ means an improved tolerance to stress factors, an improvement in plant quality, an improvement in plant vigour, and/or an improved yield.

According to the present invention, an ‘improved tolerance to stress factors’ means that certain traits are improved qualitatively or quantitatively when compared with the same trait in a control plant which has been grown under the same conditions in the absence of the method of the invention. Such traits include, but are not limited to, an increased tolerance and/or resistance to biotic stress factors which cause sub-optimal growing conditions such as an increased resistance to pressure from pests of the Coleoptera order, especially from pests of the Elateridae family, and more preferably from wireworms.

According to the present invention, an ‘improvement in plant quality’ means that certain traits are improved qualitatively or quantitatively when compared with the same trait in a control plant which has been grown under the same conditions in the absence of the method of the invention. Such traits include, but are not limited to, improved plant number, improved visual appearance of the plant, reduced ethylene (reduced production and/or inhibition of reception), improved quality of harvested material, e.g. seeds, fruits, leaves, vegetables (such improved quality may manifest as improved visual appearance of the harvested material), improved carbohydrate content (e.g. increased quantities of sugar and/or starch, improved sugar acid ratio, reduction of reducing sugars, increased rate of development of sugar), improved protein content, improved oil content and composition, improved nutritional value, reduction in anti-nutritional compounds, improved organoleptic properties (e.g. improved taste) and/or improved consumer health benefits (e.g. increased levels of vitamins and anti-oxidants)), improved post-harvest characteristics (e.g. enhanced shelf-life and/or storage stability, easier processability, easier extraction of compounds), more homogenous crop development (e.g. synchronised germination, flowering and/or fruiting of plants), and/or improved seed quality (e.g. for use in following seasons). A plant with improved quality may have an increase in any of the aforementioned traits or any combination or two or more of the aforementioned traits. In a preferred embodiment, the plant quality enhancement is an increased plant number, especially an increased plant number per row meter.

According to the present invention, an ‘improvement in plant vigour’ means that certain traits are improved qualitatively or quantitatively when compared with the same trait in a control plant which has been grown under the same conditions in the absence of the method of the invention. Such traits include, but are not limited to, early and/or improved germination, improved emergence, the ability to use less seeds, increased root growth, a more developed root system, increased root nodulation, increased shoot growth, increased tillering, stronger tillers, more productive tillers, increased or improved plant stand, less plant verse (lodging), an increase and/or improvement in plant height, an increase in plant weight (fresh or dry), bigger leaf blades, greener leaf colour, increased pigment content, increased photosynthetic activity, earlier flowering, longer panicles, early grain maturity, increased seed, fruit or pod size, increased pod or ear number, increased seed number per pod or ear, increased seed mass, enhanced seed filling, less dead basal leaves, delay of senescence, improved vitality of the plant, increased levels of amino acids in storage tissues and/or less inputs needed (e.g. less fertiliser, water and/or labour needed). A plant with improved vigour may have an increase in any of the aforementioned traits or any combination or two or more of the aforementioned traits. In a preferred embodiment, the plant vigour enhancement is an increased plant stand and/or an increased shoot growth.

Any of or all the above crop enhancements may lead to an improved yield by improving, for example, plant physiology, plant growth and development and/or plant architecture. In the context of the present invention ‘yield’ includes, but is not limited to, (i) an increase in biomass production, grain yield, starch content, oil content and/or protein content, which may result from (a) an increase in the amount produced by the plant per se or (b) an improved ability to harvest plant matter, (ii) an improvement in the composition of the harvested material (e.g. improved sugar acid ratios, improved oil composition, increased nutritional value, reduction of anti-nutritional compounds, increased consumer health benefits) and/or (iii) an increased/facilitated ability to harvest the crop, improved processability of the crop and/or better storage stability/shelf life. Increased yield of an agricultural plant means that, where it is possible to take a quantitative measurement, the yield of a product of the respective plant is increased by a measurable amount over the yield of the same product of the plant produced under the same conditions, but without application of the present invention. According to the present invention, it is preferred that the yield be increased by at least 0.5%, preferably 1%, more preferably 2%, yet more preferably 4% or more. Even more preferred is an increase in yield of at least about 5%, 10%, 15% or 20% or more. In a preferred embodiment, the yield enhancement is an increase in biomass production, grain yield, starch content, oil content and/or protein content, and more preferably in biomass production.

In a preferred embodiment, the present invention allows an improvement in tolerance to biotic stress factors, an improvement in the number of plants, an improvement in plant stand, an improvement in shoot growth, and/or an improvement in biomass production.

In the present invention, the term “plant propagation material” can be understood to denote all generative parts of a plant, such as seeds, which can be used for the multiplication of the latter including vegetative plant material such as cuttings. There may be mentioned, as plant propagation material, seeds (in the strict sense), roots, fruits, tubers, bulbs, rhizomes, parts of plants. The plant propagation material can be treated with the active ingredient(s) of the invention before the material is sown or planted. Alternatively, the plant propagation material may be treated with the active ingredient(s) of the invention during sowing or planting. Additionally, the active ingredient(s) of the invention may be applied to the previously treated propagation material before or during its planting. The active ingredient(s) of the invention may be applied during the sowing of the seed. The active ingredient(s) may also be used to plant propagation material derived from plants grown in a green house and/or during transplantation. More preferably the plant propagation material is plant seeds.

The seed treatment can occur to an unsown seed, and the term “unsown seed” is meant to include seed at any period between the harvest of the seed and the sowing of the seed in the ground for the purpose of germination and growth of the plant. Treatment to an unsown seed is not meant to include those practices in which the pesticide is applied to the soil but would include any application practice that would target the seed during the sowing/planting process.

The treated plant propagation material of the present invention can be treated in the same manner as conventional plant propagation material. The treated propagation material can be stored, handled, sown and tilled in the same manner as any other pesticide treated material.

In the present invention, the term “locus” as used herein means fields in or on which plants are growing, or where seeds of cultivated plants are sown, or where seed will be placed into the soil. It includes soil, seeds, and seedlings, as well as established vegetation.

The pesticidal combination according to the present invention can comprise a weight ratio between the active ingredients (I) and (II) of 1:1000 to 1000:1, preferably 1:100 to 100:1, preferably 1:50 to 50:1, preferably 1:50 to 1:1, and more preferably 1:10 to 1:2.

More preferably, in the pesticidal combination according to the present invention:
the application rate of active ingredient (I) is from 0.5 gram to 500 grams of active ingredient (I), preferably from 1 gram to 400 grams of active ingredient (I), and more preferably from 5 grams to 100 grams of active ingredient (I), over 100 kg of plant propagation material, and/or
the application rate of active ingredient (II) is from 10 grams to 500 grams of active ingredient (II), preferably from 10 grams to 300 grams of active ingredient (II), and more preferably from 20 grams to 200 grams, over 100 kg of plant propagation material.

In a particular embodiment, especially for cereals and pulses,
the application rate of active ingredient (I) is from 0.5 gram to 10 grams of active ingredient (I), preferably from 1 gram to 8 grams of active ingredient (I), and more preferably from 2.5 grams to 7.5 grams of active ingredient (I), over 100 kg of plant propagation material, and/or
the application rate of active ingredient (II) is from 10 gram to 50 grams of active ingredient (II), preferably from 10 grams to 40 grams of active ingredient (II), preferably from 10 grams to 30 grams of active ingredient (II), and more preferably 20 grams, over 100 kg of plant propagation material.

In another particular embodiment, especially for canola,
the application rate of active ingredient (I) is from 40 grams to 400 grams of active ingredient (I), and preferably from 40 grams to 80 grams of active ingredient (I) or from 200 grams to 400 grams of active ingredient (I), over 100 kg of plant propagation material, and/or
the application rate of active ingredient (II) is from 100 grams to 400 grams of active ingredient (II), and preferably from 100 grams to 210 grams of active ingredient (II) or 400 grams of active ingredient (II), over 100 kg of plant propagation material.

In another particular embodiment, especially for corn and soybean,
the application rate of active ingredient (I) is from 1 gram to 200 grams of active ingredient (I), preferably from 5 gram to 100 grams of active ingredient (I), and more preferably from 5 gram to 40 grams of active ingredient (I), over 100 kg of plant propagation material, and/or
the application rate of active ingredient (II) is from 10 gram to 200 grams of active ingredient (II), preferably from 50 gram to 100 grams of active ingredient (II), and more preferably from 70 gram to 80 grams of active ingredient (II), over 100 kg of plant propagation material.

In the present invention, the pesticidal combination can further comprise at least one further active ingredient, preferably at least two further active ingredients, preferably at least three further active ingredients, and more preferably the four further active ingredients, selected from difenoconazole as active ingredient (III), metalaxyl-M as active ingredient (IV), fludioxonil as active ingredient (V), and sedaxane as active ingredient (VI).

In the present invention, the active ingredients have the following CAS number: isocycloseram: 2061933-85-3; thiamethoxam: 153719-23-4; difenoconazole: 119446-68-3; metalaxyl-M: 70630-17-0; fludioxonil: 131341-86 1; sedaxane: 874967-67-6.

Isocycloseram has the following chemical formula:

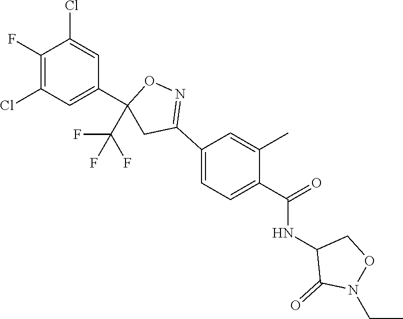 [SMILES: CCN1OCC(NC(=O)c2ccc(C3=NOC(c4cc(Cl)c(F)c(Cl)c4)(C(F)(F)F)C3)cc2C)C1=O]

Isocycloseram can comprise the isomer (5S,4R) which is 4-[(5S)-5-(3,5-dichloro-4-fluoro-phenyl)-5-(trifluoromethyl)-4H-isoxazol-3-yl]-N-[(4R)-2-ethyl-3-oxo-isoxazolidin-4-yl]-2-methyl-benzamide, and optionally at least one of the isomers selected among isomer (5S,4S), isomer (5R,4R), isomer (5R,4S), and any combinations thereof. In the present invention, the isomer (5S,4S) is 4-[(5S)-5-(3,5-dichloro-4-fluoro-phenyl)-5-(trifluoromethyl)-4H-isoxazol-3-yl]-N-[(4S)-2-ethyl-3-oxo-isoxazolidin-4-yl]-2-methyl-benzamide; the isomer (5R,4R) is 4-[(5R)-5-(3,5-dichloro-4-fluoro-phenyl)-5-(trifluoromethyl)-4H-isoxazol-3-yl]-N-[(4R)-2-ethyl-3-oxo-isoxazolidin-4-yl]-2-methyl-benzamide; and the isomer (5R,4S) is 4-[(5R)-5-(3,5-dichloro-4-fluoro-phenyl)-5-(trifluoromethyl)-4H-isoxazol-3-yl]-N-[(4S)-2-ethyl-3-oxo-isoxazolidin-4-yl]-2-methyl-benzamide. When isocycloseram further comprises at least one of the isomers selected among isomer (5S,4S), isomer (5R,4R), isomer (5R,4S), and any combinations thereof, isocycloseram can comprise a molar proportion of the isomer (5S,4R) greater than 50%, e.g. at least 55%, 60%, 65%, 70%, 75%, 80%, 85%, 90%, 95%, 96%, 97%, 98% or 99%, over the total amount of the isomers (5S,4R), (5S,4S), (5R,4R) and (5R,4S).

Metalaxyl-M is well-known under the name of Mefenoxam. Metalaxyl can be also used knowing that metalaxyl is a racemic mixture of the (R) and (S) enantiomers, so that it comprises metalaxyl-M which is the (R)-metalaxyl.

The weight ratio between any two active ingredients from (I), (II), (III), (IV), (V) and (VI), independently of each other, can range from 1:100 to 100:1, preferably from 1:50 to 50:1, and more preferably from 1:10 to 1:1 or from 1:1 to 10:1.

In a preferred embodiment, in the pesticidal combination according to the present invention, when comprising at least one of the further active ingredients (III), (IV), (V) and/or (VI),
the application rate of active ingredient (III) is from 1 gram to 25 grams of active ingredient (III), from 5 gram to 25 grams of active ingredient (III), from 5 gram to 20 grams of active ingredient (III), preferably from 5 gram to 15 grams of active ingredient (III), and more preferably 12 grams of active ingredient (III), over 100 kg of plant propagation material;
the application rate of active ingredient (IV) is from 0.5 gram to 10 grams of active ingredient (IV), preferably from 1 gram to 8 grams of active ingredient (IV), preferably from 1 gram to 5 grams of active ingredient (IV), and more preferably 3 grams, over 100 kg of plant propagation material;
the application rate of active ingredient (V) is from 0.5 gram to 10 grams of active ingredient (V), preferably from 1 gram to 5 grams of active ingredient (V), and more preferably 2.5 grams, over 100 kg of plant propagation material; and/or
the application rate of active ingredient (VI) is from 0.5 gram to 15 grams of active ingredient (VI), preferably from 1 gram to 10 grams of active ingredient (VI), and more preferably 5 grams, over 100 kg of plant propagation material.

In a most preferred embodiment, the pesticidal combination can comprise, over 100 kg of plant propagation material:
from 0.5 gram to 10 grams of active ingredient (I), and
from 10 gram to 50 grams of active ingredient (II), and

optionally:
from 1 gram to 25 grams of active ingredient (III),
from 0.5 gram to 10 grams of active ingredient (IV),
from 0.5 gram to 10 grams of active ingredient (V), and/or
from 0.5 gram to 15 grams of active ingredient (VI).

According to the present invention, the active ingredients (I) and (II), and optionally (III), (IV), (V) and (VI), can be applied in any desired sequence or simultaneously, and preferably simultaneously. More preferably, the pesticidal composition can comprise, over 100 kg of plant propagation material, from 0.5 gram to 10 grams of isocycloseram, from 10 grams to 50 grams of thiamethoxam, from 1 gram to 25 grams of metalaxyl-M, and from 0.5 gram to 10 grams of sedaxane.

A second aspect of the present invention relates to a plant propagation material, more preferably a seed, treated with the pesticidal combination defined in the present invention.

A third aspect of the present invention relates to a pesticidal combination used to treat a plant propagation material or a plant growing locus, comprising, over 100 kg of plant propagation material, from 0.5 gram to 500 grams of isocycloseram, preferably from 0.5 gram to 10 grams of isocycloseram, and from 10 grams to 500 grams of thiamethoxam, preferably from 10 gram to 50 grams of thiamethoxam, and optionally at least one further active ingredient, preferably at least two further active ingredients, preferably at least three further active ingredients, and more preferably the four further active ingredients, selected from difenoconazole, metalaxyl-M, fludioxonil, and sedaxane.

In this third aspect, the application rates of the active ingredients (I), (II), (III), (IV), (V) and (VI) are as described in the present invention.

A fourth aspect of the present invention relates to a pesticidal combination comprising isocycloseram and thiamethoxam, and optionally at least one further active ingredient, preferably at least two further active ingredients, preferably at least three further active ingredients, and more preferably the four further active ingredients, selected from fludioxonil, difenoconazole, metalaxyl-M, and sedaxane.

In a preferred embodiment, the pesticidal combination can comprise isocycloseram, thiamethoxam, and fludioxonil, and optionally at least one further active ingredient, preferably at least two further active ingredients, and more preferably the three further active ingredients, selected from difenoconazole, metalaxyl-M, and sedaxane; or the pesticidal combination can comprise isocycloseram, thiamethoxam, and metalaxyl-M, and optionally at least one further active ingredient, preferably at least two further active ingredients, and more preferably the three further active ingredients, selected from difenoconazole, fludioxonil and sedaxane.

For example, the pesticidal combination can be one of the following combinations:
isocycloseram, thiamethoxam, fludioxonil, and difenoconazole;
isocycloseram, thiamethoxam, fludioxonil, and metalaxyl-M;
isocycloseram, thiamethoxam, fludioxonil, and sedaxane;
isocycloseram, thiamethoxam, fludioxonil, difenoconazole and metalaxyl-M;
isocycloseram, thiamethoxam, fludioxonil, difenoconazole and sedaxane;
isocycloseram, thiamethoxam, fludioxonil, metalaxyl-M, and sedaxane;
isocycloseram, thiamethoxam, fludioxonil, difenoconazole, metalaxyl-M, and sedaxane.
isocycloseram, thiamethoxam, metalaxyl-M, and difenoconazole;
isocycloseram, thiamethoxam, metalaxyl-M, and sedaxane; or
isocycloseram, thiamethoxam, metalaxyl-M, difenoconazole and sedaxane.

The application rates of the active ingredients (I), (II), (III), (IV), (V) and (VI) are as described in the present invention.

In another preferred embodiment, the pesticidal combination can comprise isocycloseram, thiamethoxam, metalaxyl-M, and sedaxane, and optionally at least one further active ingredient, preferably at least two further active ingredients, and more preferably at least three further active ingredients, selected from difenoconazole, fludioxonil, picarbutrazox as active ingredient (VII), pydiflumetofen as active ingredient (VIII), thiabendazole as active ingredient (IX), ipconazole as active ingredient (X), cyclobutrifluram as active ingredient (XI), and azoxystrobin as active ingredient (XII).

For example, the pesticidal combination can be one of the following combinations:
isocycloseram, thiamethoxam, metalaxyl-M, sedaxane, and difenoconazole;
isocycloseram, thiamethoxam, metalaxyl-M, sedaxane, and fludioxonil;
isocycloseram, thiamethoxam, metalaxyl-M, sedaxane, difenoconazole, and fludioxonil;
isocycloseram, thiamethoxam, difenoconazole, metalaxyl-M, sedaxane, and picarbutrazox;
isocycloseram, thiamethoxam, fludioxonil, difenoconazole, metalaxyl-M, sedaxane, and picarbutrazox;
isocycloseram, thiamethoxam, difenoconazole, metalaxyl-M, sedaxane, picarbutrazox, pydiflumetofen, and thiabendazole;
isocycloseram, thiamethoxam, fludioxonil, metalaxyl-M, sedaxane, picarbutrazox, pydiflumetofen, and ipconazole;
isocycloseram, thiamethoxam, metalaxyl-M, sedaxane, fludioxonil, difenoconazole, and picabutrazox;
isocycloseram, thiamethoxam, metalaxyl-M, sedaxane, fludioxonil, difenoconazole, and pydiflumetofen; or
isocycloseram, thiamethoxam, metalaxyl-M, sedaxane, fludioxonil, difenoconazole, and cyclobutrifluram.

The application rates of the active ingredients (I), (II), (III), (IV), (V) and (VI) are as described in the present invention.

In the pesticidal combination according to the present invention, when comprising at least one or several of the further active ingredients (VII), (VIII), (IX), (X), (XI) and/or (XII),
the application rate of active ingredient (VII) is from 0.5 gram to 10 grams of active ingredient (VII), and preferably from 1.5 gram to 2.5 grams of active ingredient (VII), over 100 kg of plant propagation material;
the application rate of active ingredient (VIII) is from 1 gram to 40 grams of active ingredient (VIII), and preferably from 10 gram to 20 grams of active ingredient (VIII), over 100 kg of plant propagation material;
the application rate of active ingredient (IX) is from 1 gram to 200 grams of active ingredient (IX), and preferably from 5 gram to 130 grams of active ingredient (IX), over 100 kg of plant propagation material;
the application rate of active ingredient (X) is from 0.5 gram to 5 grams of active ingredient (X), preferably from 1 gram to 3 grams of active ingredient (X), and more preferably from 1.5 gram to 2.5 grams of active ingredient of active ingredient (X), over 100 kg of plant propagation material;
the application rate of active ingredient (XI) is from 1 gram to 10 grams of active ingredient (XI), and preferably from 2 grams to 8 grams of active ingredient (XI), over 100 kg of plant propagation material; and/or
the application rate of active ingredient (XII) is from 0.5 gram to 5 grams of active ingredient (XII), preferably from 1 gram to 3 grams of active ingredient (XII), and more preferably from 1.5 gram to 2.5 grams of active ingredient (XII), over 100 kg of plant propagation material.

In the present invention, further active ingredients can be combined with the active ingredient (I), said further active ingredients can be selected from acibenzolar-s-methyl, metalaxyl-M, metalaxyl, picarbutrazox, oxathiapiprolin, ethaboxam, fludioxonil, azoxystrobin, thiabendazole, difenoconazole, tebuconazole, ipconazole, mefentrifluconazole, prothioconazole, triticonazole, sedaxane, inpyrfluxam, penflufen, fluopyram, fluxapyroxad, pydiflumetofen, cyclobutrifluram, thiamethoxam, isoflucypram, clothianidin, benzovindiflupyr, cymoxanil, phosphite (phosphonate), silthiofam, pyraclostrobin, isotianil, tolprocarb, quinofumelin, ipflufenoquin, metyltetraprole, florylpicoxamid, fenpicoxamid, fluoxytioconazole, fluindapyr, fluoxapiprolin, broflanilide, imidacloprid, acetamiprid, cyantraniliprole, chlorantraniliprole, tetraniliprole, fluxamethamide, penthiopyrad, mandipropamid, dimpropyridaz, flupyrimin, triflumezopyrim, oxazosulfyl, dichlobentiazox, benzpirimoxan, hymexazol, pyrapropoyne, cyclaniliprole, mandestrobin, copper, lambda-cyhalothrin, phenamacril, abamectin, tefluthrin, picoxystrobin, spiropidion, oligosaccharins, Melaleuca alternifolia, natamycin, fosthiazate, fenamifos, oxamyl, fluensulfone, fluazanindolizine, spirotetramat, spidoxamat, fluazinam, indazapyroxamet, thiophanate methyl, zoxamide, fluoxastrobin, pirimifos, tetrachlorantraniliprole, bifenthrin, emamectin benzoate, metyltetraprole, dimethomorph, and combinations thereof.

The application rate of the active ingredient (I) is as described in the present invention. The weight ratio of active ingredient (I) to each of said further active ingredients can range from 1:100 to 100:1, preferably from 1:50 to 50:1, and more preferably from 1:10 to 1:1 or from 1:1 to 10:1.

In the present invention, further active ingredients can be combined with the active ingredient (II), said further active ingredients can be selected from acibenzolar-s-methyl, metalaxyl-M, metalaxyl, picarbutrazox, oxathiapiprolin, ethaboxam, fludioxonil, azoxystrobin, thiabendazole, difenoconazole, tebuconazole, ipconazole, mefentrifluconazole, prothioconazole, triticonazole, sedaxane, inpyrfluxam, penflufen, fluopyram, fluxapyroxad, pydiflumetofen, cyclobutrifluram, isocycloseram, isoflucypram, clothianidin, benzovindiflupyr, cymoxanil, phosphite (phosphonate), silthiofam, pyraclostrobin, isotianil, tolprocarb, quinofumelin, ipflufenoquin, metyltetraprole, florylpicoxamid, fenpicoxamid, fluoxytioconazole, fluindapyr, fluoxapiprolin, broflanilide, imidacloprid, acetamiprid, cyantraniliprole, chlorantraniliprole, tetraniliprole, fluxamethamide, penthiopyrad, mandipropamid, dimpropyridaz, flupyrimin, triflumezopyrim, oxazosulfyl, dichlobentiazox, benzpirimoxan, hymexazol, pyrapropoyne, cyclaniliprole, mandestrobin, copper, lambda-cyhalothrin, phenamacril, abamectin, tefluthrin, picoxystrobin, spiropidion, oligosaccharins, Melaleuca alternifolia, natamycin, Trichoderma harzianum, fosthiazate, fenamifos, oxamyl, fluensulfone, fluazanindolizine, spirotetramat, spidoxamat, fluazinam, indazapyroxamet, thiophanate methyl, zoxamide, fluoxastrobin, pirimifos, tetrachlorantraniliprole, bifenthrin, emamectin benzoate, metyltetraprole, dimethomorph, and combinations thereof.

The application rate of the active ingredient (II) is as described in the present invention. The weight ratio of active ingredient (II) to each of said further active ingredients can range from 1:100 to 100:1, preferably from 1:50 to 50:1, and more preferably from 1:10 to 1:1 or from 1:1 to 10:1.

A fifth aspect of the present invention relates to a method of controlling, limiting or preventing an infestation of a plant against pests of the Coleoptera order such as Elateridae family (e.g. wireworms), which comprises applying to a propagation material of said plant or a growing locus of said plant, a pesticidal combination comprising at least isocycloseram as active ingredient (I) and thiamethoxam as active ingredient (II), and optionally at least one further active ingredient, preferably at least two further active ingredients, preferably at least three further active ingredients, and more preferably the four further active ingredients, selected from difenoconazole, metalaxyl-M, fludioxonil, and sedaxane.

In this fifth aspect, the application rates of the different active ingredients are as described in the present invention.

The term “plant” as used in the present description includes seedlings, bushes and trees. Suitable target crops are, in particular, cereals, such as wheat, barley, rye, oats, rice, maize (e.g. field corn, popcorn, corn), millet or sorghum; beet, such as sugar or fodder beet; fruit, for example pomaceous fruit, stone fruit or soft fruit, such as apples, pears, plums, peaches, almonds, cherries or berries, for example strawberries, raspberries or blackberries; leguminous crops, such as beans, lentils, peas or soya (soya beans); pulses; oil crops, such as oilseed rape, mustard, poppies, olives, sunflowers, coconut, castor, cocoa or ground nuts; cucurbits, such as pumpkins, cucumbers, melons, watermelons or squashes; fibre plants, such as cotton, flax, hemp or jute; citrus fruit, such as oranges, lemons, grapefruit or tangerines; vegetables, such as spinach, lettuce, asparagus, cabbages, broccolis, cauliflowers, carrots, onions, tomatoes, potatoes, eggplants, peppers or bell peppers; Lauraceae, such as avocado, Cinnamonium or camphor; and also tobacco, nuts, coffee, sugarcane, tea, grapevines, hops, the plantain family and latex plant. Preferably the plant is a cereal, a pulse, canola, soybean or corn; in particular wheat or canola, preferably spring wheat.

Crops are to be understood as being those which are naturally occurring, obtained by conventional methods of breeding, or obtained by genetic engineering. They include crops which contain so-called output traits (e.g. improved storage stability, higher nutritional value and improved flavour).

Crops are to be understood as also including those crops which have been rendered tolerant to herbicides like bromoxynil or classes of herbicides such as ALS-, EPSPS-, GS-, HPPD- and PPO-inhibitors. An example of a crop that has been rendered tolerant to imidazolinones, for example imazamox, by conventional methods of breeding is Clearfield® summer canola. Examples of crops that have been rendered tolerant to herbicides by genetic engineering methods include e.g. glyphosate- and glufosinate-resistant maize varieties commercially available under the trade names RoundupReady®, Herculex I® and LibertyLink®.

Crops are also to be understood as being those which naturally are or have been rendered resistant to harmful insects. This includes plants transformed by the use of recombinant DNA techniques, for example, to be capable of synthesising one or more selectively acting toxins, such as are known, for example, from toxin-producing bacteria. Examples of toxins which can be expressed include 6-endotoxins, vegetative insecticidal proteins (Vip), insecticidal proteins of bacteria colonising nematodes, and toxins produced by scorpions, arachnids, wasps and fungi.

An example of a crop that has been modified to express the Bacillus thuringiensis toxin is KnockOut® (Syngenta Seeds), the Intacta® (BASF) or Yield Gard®. An example of a crop comprising more than one gene that codes for insecticidal resistance and thus expresses more than one toxin is VipCot® (Syngenta Seeds). Crops or seed material thereof can also be resistant to multiple types of pests (so-called stacked transgenic events when created by genetic modification). For example, a plant can have the ability to express an insecticidal protein while at the same time being herbicide tolerant, for example Herculex I® (Dow AgroSciences, Pioneer Hi-Bred International).

The genetic modified crops can be described in the following website https://www.isaaa.org/gmaapprovaldatabase, incorporated by reference therein, and more particularly can be selected from:

| | |
|---|---|
| Event Name and Code | Trade Name |

Maize - Zea mays L.: 152 Events

| | |
|---|---|
| Name: 32138 | 32138 SPT maintainer |
| Code: DP-32138-1 | |
| Name: 3272 | Enogen ™ |
| Code: SYN-E3272-5 | |
| Name: 3272 × Bt11 × 59122 × MIR604 × TC1507 × GA21 | not available |
| Code: SYN-E3272-5 × SYN-BTØ11-1 × DAS-59122-7 × SYN- | |
| IR604-5 × DAS-Ø1507-1 × MON-ØØØ21-9 | |
| Name: 3272 × Bt11 × MIR604 × GA21 | not available |
| Code: SYN-E3272-5 × SYN-BTØ11-1 × SYN-IR6Ø4-5 × MON- | |
| ØØØ21-9 | |
| Name: 3272 × Bt11 × MIR604 × TC1507 × 5307 × GA21 | not available |
| Code: SYN-E3272-5 × SYN-BTØ11-1 × SYN-IR6Ø4-5 × DAS- | |
| Ø15Ø7-1 × SYN-Ø53Ø7-1 × MON-ØØØ21-9 | |
| Name: 4114 | not available |
| Code: DP-ØØ4114-3 | |
| Name: 5307 | Agrisure ® Duracade ™ |
| Code: SYN-Ø53Ø7-1 | |
| Name: 5307 × MIR604 × Bt11 × TC1507 × GA21 | Agrisure ® Duracade ™ 5122 |
| Code: SYN-Ø53Ø7-1 × SYN-IR6Ø4-5 × SYN-BTØ11-1 × DAS- | |
| Ø15Ø7-1 × MON-ØØØ21-9 | |
| Name: 5307 × MIR604 × Bt11 × TC1507 × GA21 × MIR162 | Agrisure ® Duracade ™ 5222 |
| Code: SYN-Ø53Ø7-1 × SYN-IR6Ø4-5 × SYN-BTØ11-1 × DAS- | |
| Ø15Ø7-1 × MON-ØØØ21-9 × SYN-IR 162-4 | |
| Name: 59122 | Herculex ™ RW |
| Code: DAS-59122-7 | |
| Name: 59122 × MON88017 | not available |
| Code: DAS-59122-7 × MON-88Ø17-3 | |
| Name: 59122 × NK603 | Herculex ™ RW Roundup Ready ™ 2 |
| Code: DAS-59122-7 × MON-ØØ6Ø3-6 | |
| Name: 676 | not available |
| Code: PH-ØØØ676-7 | |
| Name: 678 | not available |
| Code: PH-ØØØ678-9 | |
| Name: 680 | not available |
| Code: PH-ØØØ68Ø-2 | |
| Name: 98140 | Optimum ™ GAT ™ |
| Code: DP-Ø9814Ø-6 | |
| Name: 98140 × 59122 | not available |
| Code: DP-Ø9814Ø-6 × DAS-59122-7 | |
| Name: 98140 × TC1507 | not available |
| Code: DP-Ø9814Ø-6 × DAS-Ø15Ø7-1 | |
| Name: 98140 × TC1507 × 59122 | not available |
| Code: DP-Ø9814Ø-6 × DAS-Ø15Ø7-1 × DAS-59122-7 | |
| Name: Bt10 | Bt10 |
| Code: not available | |
| Name: Bt11 (X4334CBR, X4734CBR) | Agrisure ™ CB/LL |
| Code: SYN-BTØ11-1 | |
| Name: Bt11 × 5307 | not available |
| Code: SYN-BTØ11-1 × SYN-Ø53Ø7-1 | |
| Name: Bt11 × 59122 × MIR604 × TC1507 × GA21 | Agrisure ® 3122 |
| Code: SYN-BTØ11-1 × DAS-59122-7 × SYN-IR6Ø4-5 × DAS- | |
| Ø15Ø7-1 × MON-ØØØ21-9 | |
| Name: Bt11 × GA21 | Agrisure ™ GT/CB/LL |
| Code: SYN-BTØ11-1 × MON-ØØØ21-9 | |
| Name: Bt11 × MIR162 | Agrisure ® Viptera ™ 2100 |
| Code: SYN-BTØ11-1 × SYN-IR162-4 | |
| Name: Bt11 × MIR162 × GA21 | Agrisure ® Viptera ™ 3110 |
| Code: SYN-BTØ11-1 × SYN-IR162-4 × MON-ØØØ21-9 | |
| Name: BT11 × MIR162 × MIR604 | Agrisure ® Viptera ™ 3100 |
| Code: SYN-BTØ11-1 × SYN-IR 162-4 × SYN-IR6Ø4-5 | |
| Name: Bt11 × MIR162 × MIR604 × GA21 | Agrisure ® Viptera ™ 3111, Agrisure ® |
| Code: SYN-BTØ11-1 × SYN-IR162-4 × SYN-IR6Ø4-5 × MON- | Viptera ™ 4 |
| ØØØ21-9 | |
| Name: Bt11 × MIR162 × MIR604 × MON89034 × 5307 × GA21 | not available |
| Code: SYN-BTØ11-1 × SYN-IR162-4 × SYN-IR6Ø4-5 × MON- | |
| 89Ø34-3 × SYN-Ø53Ø7-1 × MON-ØØØ21-9 | |
| Name: BT11 × MIR162 × MIR604 × TC1507 | not available |
| Code: SYN-BTØ11-1 × SYN-IR162-4 × SYN-IR6Ø4-5 × DAS- | |
| Ø15Ø7-1 | |
| Name: BT11 × MIR162 × MIR604 × TC1507 × 5307 | not available |
| Code: SYN-BTØ11-1 × SYN-IR162-4 × SYN-IR6Ø4-5 × DAS- | |
| Ø15Ø7-1 × SYN-Ø53Ø7-1 | |
| Name: Bt11 × MIR162 × MON89034 | not available |
| Code: SYN-BTØ11-1 × SYN-IR162-4 × MON-89Ø34-3 | |
| Name: Bt11 × MIR162 × MON89034 × GA21 | not available |
| Code: SYN-BTØ11-1 × SYN-IR162-4 × MON-89Ø34-3 × MON- | |
| ØØØ21-9 | |
| Name: Bt11 × MIR162 × TC1507 | not available |
| Code: SYN-BTØ11-1 × SYN-IR162-4 × DAS-Ø15Ø7-1 | |
| Name: Bt11 × MIR162 × TC1507 × GA21 | Agrisure ™ Viptera 3220 |
| Code: SYN-BTØ11-1 × SYN-IR162-4 × DAS-Ø15Ø7-1 × MON- | |
| ØØØ21-9 | |
| Name: Bt11 × MIR604 | Agrisure ™ CB/LL/RW |
| Code: SYN-BTØ11-1 × SYN-IR6Ø4-5 | |
| Name: Bt11 × MIR604 × GA21 | Agrisure ™ 3000GT |
| Code: SYN-BTØ11-1 × SYN-IR6Ø4-5 × MON-ØØØ21-9 | |
| Name: Bt11 × MON89034 | not available |
| Code: SYN-BTØ11-1 × MON-89Ø34-3 | |
| Name: Bt11 × MON89034 × GA21 | not available |
| Code: SYN-BTØ11-1 × MON-89Ø34-3 × MON-ØØØ21-9 | |
| Name: Bt11 × TC1507 | not available |
| Code: SYN-BTØ11-1 × DAS-Ø15Ø7-1 | |
| Name: Bt11 × TC1507 × GA21 | not available |
| Code: SYN-BTØ11-1 × DAS-Ø15Ø7-1 × MON-ØØØ21-9 | |
| Name: Bt176 (176) | NaturGard KnockOut ™, Maximizer ™ |
| Code: SYN-EV176-9 | |
| Name: BVLA430101 | not available |
| Code: not available | |
| Name: CBH-351 | Starlink ™ Maize |
| Code: ACS-ZMØØ4-3 | |
| Name: DAS40278 | Enlist ™ Maize |
| Code: DAS-4Ø278-9 | |
| Name: DAS40278 × NK603 | not available |
| Code: DAS-4Ø278-9 × MON-ØØ6Ø3-6 | |
| Name: DBN9501 | not available |
| Code: DBN-Ø95Ø1-8 | |
| Name: DBN9858 | not available |
| Code: DBN-Ø9858-5 | |
| Name: DBN9936 | not available |
| Code: DBN-Ø9936-2 | |
| Name: DBT418 | Bt Xtra ™ Maize |
| Code: DKB-89614-9 | |
| Name: DLL25 (B16) | not available |
| Code: DKB-8979Ø-5 | |
| Name: DP202216 | not available |
| Code: DP-2Ø2216-6 | |
| Name: GA21 | Roundup Ready ™ Maize, |
| Code: MON-ØØØ21-9 | Agrisure ™GT |
| Name: GA21 × MON810 | Roundup Ready ™ YieldGard ™ maize |
| Code: MON-ØØØ21-9 × MON-ØØ81Ø-6 | |
| Name: GA21 × T25 | not available |
| Code: MON-ØØØ21-9 × ACS-ZMØØ3-2 | |
| Name: HCEM485 | not available |
| Code: HCEM485 | |
| Name: LY038 | Mavera ™ Maize |
| Code: REN-ØØØ38-3 | |
| Name: LY038 × MON810 | Mavera ™ YieldGard ™ Maize |
| Code: REN-ØØØ38-3 × MON-ØØ81Ø-6 | |
| Name: MIR162 | Agrisure ™ Viptera |
| Code: SYN-IR162-4 | |
| Name: MIR162 × GA21 | not available |
| Code: SYN-IR162-4 × MON-ØØØ21-9 | |
| Name: MIR162 × MIR604 | not available |
| Code: SYN-IR162-4 × SYN-IR6Ø4-5 | |
| Name: MIR162 × MIR604 × GA21 | not available |
| Code: SYN-IR162-4 × SYN-IR6Ø4-5 × MON-ØØØ21-9 | |
| Name: MIR162 × MIR604 × TC1507 | not available |
| Code: SYN-IR162-4 × SYN-IR6Ø4-5 × DAS-Ø15Ø7-1 | |
| Name: MIR162 × MIR604 × TC1507 × 5307 | not available |
| Code: SYN-IR162-4 × SYN-IR6Ø4-5 × DAS-Ø15Ø7-1 × SYN- | |
| Ø53Ø7-1 | |
| Name: MIR162 × MIR604 × TC1507 × 5307 × GA21 | not available |
| Code: SYN-IR162-4 × SYN-IR6Ø4-5 × DAS-Ø15Ø7-1 × SYN- | |
| Ø53Ø7-1 × MON-ØØØ21-9 | |
| Name: MIR162 × MON89034 | not available |
| Code: SYN-IR162-4 × MON-89Ø34-3 | |
| Name: MIR162 × MON89034 × GA21 | not available |
| Code: SYN-IR162-4 × MON-89Ø34-3 × MON-ØØØ21-9 | |
| Name: MIR162 × NK603 | not available |
| Code: SYN-IR162-4 × MON-ØØ6Ø3-6 | |
| Name: MIR162 × TC1507 | not available |
| Code: SYN-IR162-4 × DAS-Ø15Ø7-1 | |
| Name: MIR162 × TC1507 × GA21 | not available |
| Code: SYN-IR162-4 × DAS-Ø15Ø7-1 × MON-ØØØ21-9 | |
| Name: MIR604 | Agrisure ™ RW |
| Code: SYN-IR6Ø4-5 | |
| Name: MIR604 × GA21 | Agrisure ™ GT/RW |
| Code: SYN-IR6Ø4-5 × MON-ØØØ21-9 | |
| Name: MON801 (MON80100) | not available |
| Code: MON8Ø1 | |
| Name: MON802 | not available |
| Code: MON-8Ø2ØØ-7 | |
| Name: MON809 | not available |
| Code: PH-MON-8Ø9-2 | |
| Name: MON810 | YieldGard ™, MaizeGard ™ |
| Code: MON-ØØ81Ø-6 | |
| Name: MON810 × MIR162 | not available |
| Code: MON-ØØ81Ø-6 × SYN-IR162-4 | |
| Name: MON810 × MIR162 × NK603 | n/a |
| Code: MON-ØØ81Ø-6 × SYN-IR162-4 × MON-ØØ6Ø3-6 | |
| Name: MON810 × MON88017 | YieldGard ™ VT Triple |
| Code: MON-ØØ81Ø-6 × MON-88Ø17-3 | |
| Name: MON832 | Roundup Ready ™ Maize |
| Code: not available | |
| Name: MON863 | YieldGard ™ Rootworm RW. |
| Code: MON-ØØ863-5 | MaxGard ™ |
| Name: MON863 × MON810 | YieldGard ™ Plus |
| Code: MON-ØØ863-5 × MON-ØØ81Ø-6 | |
| Name: MON863 × MON810 × NK603 | YieldGard ™ Plus with RR |
| Code: MON-ØØ6Ø3-6 × MON-ØØ81Ø-6 × MON-ØØ863-5 | |
| Name: MON863 × NK603 | YieldGard ™ RW + RR |
| Code: MON-ØØ863-5 × MON-ØØ6Ø3-6 | |
| Name: MON87403 | not available |
| Code: MON874Ø3-1 | |
| Name: MON87411 | not available |
| Code: MON-87411-9 | |
| Name: MON87419 | n/a |
| Code: MON87419-8 | |
| Name: MON87427 | Roundup Ready ™ Maize |
| Code: MON-87427-7 | |
| Name: MON87427 × MON89034 × MIR162 × MON87419 × | not available |
| NK603 | |
| Code: MON-87427-7 × MON-89Ø34-3 × SYN-IR162-4 × | |
| MON87419-8 × MON-ØØ6Ø3-6 | |
| Name: MON87427 × MON89034 × MON810 × MIR162 × | not available |
| MON87411 × MON87419 | |
| Code: MON-87427-7 × MON-89Ø34-3 × MON-ØØ81Ø-6 × SYN- | |
| IR162-4 × MON-87411-9 × MON87419-8 | |
| Name: MON87427 × MON87419 × NK603 | not available |
| Code: MON-87427-7 × MON87419-8 × MON-ØØ6Ø3-6 | |
| Name: MON87427 × MON87460 × MON89034 × TC1507 × | not available |
| MON87411 × 59122 | |
| Code: MON-87427-7 × MON-8746Ø-4 × MON-89Ø34-3 × DAS- | |
| Ø15Ø7-1 × MON-87411-9 × DAS-59122-7 | |
| Name: MON87427 × MON89034 × MIR162 × MON87411 | not available |
| Code: MON-87427-7 × MON-89Ø34-3 × SYN-IR162-4 × MON- | |
| 87411-9 | |
| Name: MON87427 × MON89034 × MIR162 × NK603 | n/a |
| Code: MON-87427-7 × MON-89Ø34-3 × SYN-IR162-4 × MON- | |
| ØØ6Ø3-6 | |
| Name: MON87427 × MON89034 × MON88017 | not available |
| Code: MON-87427-7 × MON-89Ø34-3 × MON-88Ø17-3 | |
| Name: MON87427 × MON89034 × NK603 | not available |
| Code: MON-87427-7 × MON-89Ø34-3 × MON-ØØ6Ø3-6 | |
| Name: MON87427 × MON89034 × TC1507 × MON87411 × | not available |
| 59122 | |
| Code: MON-87427-7 × MON-89Ø34-3 × DAS-Ø15Ø7-1 × MON- | |
| 87411-9 × DAS-59122-7 | |
| Name: MON87427 × MON89034 × TC1507 × MON87411 × | SmartStax ™ Pro × Enlist ™ |
| 59122 × DAS40278 | |
| Code: MON-87427-7 × MON-89Ø34-3 × DAS-Ø15Ø7-1 × MON- | |
| 87411-9 × DAS-59122-7 × DAS-4Ø278-9 | |
| Name: MON87427 × MON89034 × TC1507 × MON87411 × | not available |
| 59122 × MON87419 | |
| Code: MON-87427-7 × MON-89Ø34-3 × DAS-Ø15Ø7-1 × MON- | |
| 87411-9 × DAS-59122-7 × MON87419-8 | |
| Name: MON87427 × MON89034 × TC1507 × MON88017 × | not available |
| 59122 | |
| Code: MON-87427-7 × MON-89Ø34-3 × DAS-Ø15Ø7-1 × MON- | |
| 88Ø17-3 × DAS-59122-7 | |
| Name: MON87429 | NA |
| Code: MON-87429-9 | |
| Name: MON87460 | Genuity ® DroughtGard ™ |
| Code: MON-8746Ø-4 | |
| Name: MON87460 × MON89034 × MON88017 | not available |
| Code: MON-8746Ø-4 × MON-89Ø34-3 × MON-88Ø17-3 | |
| Name: MON87460 × MON89034 × NK603 | not available |
| Code: MON-8746Ø-4 × MON-89Ø34-3 × MON-ØØ6Ø3-6 | |
| Name: MON87460 × NK603 | not available |
| Code: MON-8746Ø-4 × MON-ØØ6Ø3-6 | |
| Name: MON88017 | YieldGard ™ VT ™ Rootworm ™ RR2 |
| Code: MON-88Ø17-3 | |
| Name: MON89034 | YieldGard ™ VT Pro ™ |
| Code: MON-89Ø34-3 | |
| Name: MON89034 × 59122 | not available |
| Code: MON-89Ø34-3 × DAS-59122-7 | |
| Name: MON89034 × 59122 × MON88017 | not available |
| Code: MON-89Ø34-3 × DAS-59122-7 × MON-88Ø17-3 | |
| Name: MON89034 × GA21 | not available |
| Code: MON-89Ø34-3 × MON-ØØØ21-9 | |
| Name: MON89034 × MON87460 | not available |
| Code: MON-89Ø34-3 × MON-8746Ø-4 | |
| Name: MON89034 × MON88017 | Genuity ® VT Triple Pro ™ |
| Code: MON-89Ø34-3 × MON-88Ø17-3 | |
| Name: MON89034 × NK603 | Genuity ® VT Double Pro ™ |
| Code: MON-89Ø34-3 × MON-ØØ6Ø3-6 | |
| Name: MON89034 × TC1507 | not available |
| Code: MON-89Ø34-3 × DAS-Ø15Ø7-1 | |
| Name: MON89034 × TC1507 × 59122 | not available |
| Code: MON-89Ø34-3 × DAS-Ø15Ø7-1 × DAS-59122-7 | |
| Name: MON89034 × TC1507 × MON88017 | not available |
| Code: MON-89Ø34-3 × DAS-Ø15Ø7-1 × MON-88Ø17-3 | |
| Name: MON89034 × TC 1507 × MON88017 × 59122 | Genuity ® SmartStax ™ |
| Code: MON-89Ø34-3 × DAS-Ø15Ø7-1 × MON-88Ø17-3 × DAS- | |
| 59122-7 | |
| Name: MON89034 × TC1507 × MON88017 × 59122 × DAS40278 | not available |
| Code: MON-89Ø34-3 × DAS-Ø15Ø7-1 × MON-88Ø17-3 × DAS- | |
| 59122-7 × DAS-4Ø278-9 | |
| Name: MON89034 × TC1507 × NK603 | Power Core ™ |
| Code: MON-89Ø34-3 × DAS-Ø15Ø7-1 × MON-ØØ6Ø3-6 | |
| Name: MON89034 × TC1507 × NK603 × DAS40278 | not available |
| Code: MON-89Ø34-3 × DAS-Ø15Ø7-1 × MON-ØØ6Ø3-6 × DAS- | |
| 40278-9 | |
| Name: MON89034 × TC1507 × NK603 × MIR162 | not available |
| Code: MON-89Ø34-3 × DAS-Ø15Ø7-1 × MON-ØØ6Ø3-6 × SYN- | |
| IR162-4 | |
| Name: MON89034 × TC1507 × NK603 × MIR162 × DAS40278 | Power Core ™ × MIR162 × Enlist ™ |
| Code: MON-89Ø34-3 × DAS-Ø15Ø7-1 × MON-ØØ6Ø3-6 × SYN- | |
| IR162-4 × DAS-4Ø278-9 | |
| Name: MS3 | InVigor ™ Maize |
| Code: ACS-ZMØØ1-9 | |
| Name: MS6 | InVigor ™ Maize |
| Code: ACS-ZMØØ5-4 | |
| Name: MZHGOJG | n/a |
| Code: SYN-ØØØJG-2 | |
| Name: MZIR098 | not available |
| Code: SYN-ØØØ98-3 | |
| Name: NK603 | Roundup Ready ™ 2 Maize |
| Code: MON-ØØ6Ø3-6 | |
| Name: NK603 × MON810 × 4114 × MIR604 | Not available |
| Code: MON-00603-6 × MON-00810-6 × DP004114-3 × SYN- | |
| IR604-4 | |
| Name: NK603 × MON810 | YieldGard ™ CB + RR |
| Code: MON-ØØ6Ø3-6 × MON-ØØ81Ø-6 | |
| Name: NK603 × T25 | Roundup Ready ™ Liberty Link ™ |
| Code: MON-ØØ6Ø3-6 × ACS-ZMØØ3-2 | Maize |
| Name: PY203 | GralNzyme Phytase |
| Code: AGV-PY2Ø3-4 | |
| Name: T14 | Liberty Link ™ Maize |
| Code: ACS-ZMØØ2-1 | |
| Name: T25 | Liberty Link ™ Maize |
| Code: ACS-ZMØØ3-2 | |
| Name: T25 × MON810 | Liberty Link ™ Yieldgard ™ Maize |
| Code: ACS-ZMØØ3-2 × MON-ØØ81Ø-6 | |
| Name: TC1507 | Herculex ™ I, Herculex ™ CB |
| Code: DAS-Ø15Ø7-1 | |
| Name: TC1507 × 59122 × MON810 × MIR604 × NK603 | Optimum ™ Intrasect Xtreme |
| Code: DAS-Ø15Ø7-1 × DAS-59122-7 × MON-ØØ81Ø-6 × SYN- | |
| IR6Ø4-5 × MON-ØØ6Ø3-6 | |
| Name: TC1507 × MON810 × MIR604 × NK603 | not available |
| Code: DAS-Ø15Ø7-1 × MON-ØØ81Ø-6 × SYN-IR6Ø4-5 × MON- | |
| ØØ6Ø3-6 | |
| Name: TC1507 × 59122 | Herculex XTRA ™ |
| Code: DAS-Ø15Ø7-1 × DAS-59122-7 | |
| Name: TC1507 × 59122 × MON810 × NK603 | Optimum ™ Intrasect XTRA |
| Code: DAS-Ø15Ø7-1 × DAS-59122-7 × MON-ØØ81Ø-6 × MON- | |
| ØØ6Ø3-6 | |
| Name: TC1507 × 59122 × MON88017 | not available |
| Code: DAS-Ø15Ø7-1 × DAS-59122-7 × MON-88Ø17-3 | |
| Name: TC1507 × 59122 × NK603 | Herculex XTRA ™ RR |
| Code: DAS-Ø15Ø7-1 × DAS-59122-7 × MON-ØØ6Ø3-6 | |
| Name: TC1507 × MIR162 × NK603 | not available |
| Code: DAS-Ø15Ø7-1 × SYN-IR162-4 × MON-ØØ6Ø3-6 | |
| Name: TC1507 × MIR604 × NK603 | Optimum ™ TRIsect |
| Code: DAS-Ø15Ø7-1 × SYN-IR6Ø4-5 × MON-ØØ6Ø3-6 | |
| Name: TC1507 × MON810 | not available |
| Code: DAS-Ø15Ø7-1 × MON-ØØ81Ø-6 | |
| Name: TC1507 × MON810 × MIR162 | not available |
| Code: DAS-Ø15Ø7-1 × MON-ØØ81Ø-6 × SYN-IR162-4 | |
| Name: TC1507 × MON810 × MIR162 × NK603 | not available |
| Code: DAS-Ø15Ø7-1 × MON-ØØ81Ø-6 × SYN-IR162-4 × MON- | |
| ØØ6Ø3-6 | |
| Name: TC1507 × MON810 × NK603 | Optimum ™ Intrasect |
| Code: DAS-Ø15Ø7-1 × MON-ØØ81Ø-6 × MON-ØØ6Ø3-6 | |
| Name: TC1507 × MON810 × NK603 × MIR604 | not available |
| Code: DAS-Ø15Ø7-1 × MON-ØØ81Ø-6 × MON-ØØ6Ø3-6 × SYN- | |
| IR6Ø4-5 | |
| Name: TC1507 × MON88017 | not available |
| Code: DAS-Ø15Ø7-1 × MON-88Ø17-3 | |
| Name: TC1507 × NK603 | Herculex ™ I RR |
| Code: DAS-Ø15Ø7-1 × MON-ØØ6Ø3-6 | |
| Name: TC6275 | not available |
| Code: DAS-Ø6275-8 | |
| Name: VCO-01981-5 | not available |
| Code: VCO-Ø1981-5 | |

Soybean - Glycine max L.: 40 Events

| | |
|---|---|
| Name: 260-05 (G94-1, G94-19, G168) | not available |
| Code: DD-Ø26ØØ5-3 | |
| Name: A2704-12 | Liberty Link ® soybean |
| Code: ACS-GMØØ5-3 | |
| Name: A2704-21 | Liberty Link ® soybean |
| Code: ACS-GMØØ4-2 | |
| Name: A5547-127 | Liberty Link ® soybean |
| Code: ACS-GMØØ6-4 | |
| Name: A5547-35 | Liberty Link ® soybean |
| Code: ACS-GMØØ8-6 | |
| Name: CV127 | Cultivance |
| Code: BPS-CV127-9 | |
| Name: DAS44406-6 | not available |
| Code: DAS-444Ø6-6 | |
| Name: DAS68416-4 | not available |
| Code: DAS-68416-4 | |
| Name: DAS68416-4 × MON89788 | not available |
| Code: DAS-68416-4 × MON-89788-1 | |
| Name: DAS81419 | not available |
| Code: DAS-81419-2 | |
| Name: DAS81419 × DAS44406 | Conkesta Enlist E3 ™ Soybean |
| Code: DAS-81419-2 × DAS-444Ø6-6 | |
| Name: DBN9004 | not available |
| Code: DBN-Ø9ØØ4-6 | |
| Name: DP305423 | Treus ™, Plenish ™ |
| Code: DP-3Ø5423-1 | |
| Name: DP305423 × GTS 40-3-2 | not available |
| Code: DP-3Ø5423-1 × MON-Ø4Ø32-6 | |
| Name: DP305423 × MON87708 × MON89788 | not available |
| Code: DP-3Ø5423-1 × MON-877Ø8-9 × MON-89788-1 | |
| Name: DP356043 | Optimum GAT ™ |
| Code: DP-356Ø43-5 | |
| Name: FG72 (FGØ72-2, FGØ72-3) | not available |
| Code: MST-FGØ72-2 | |
| Name: FG72 × A5547-127 | Liberty Link ® GT27 ™ |
| Code: MST-FGØ72-2 × ACS-GMØØ6-4 | |
| Name: GMB151 | not available |
| Code: BCS-GM151-6 | |
| Name: GTS 40-3-2 (40-3-2) | Roundup Ready ™ soybean |
| Code: MON-Ø4Ø32-6 | |
| Name: GU262 | Liberty Link ™ soybean |
| Code: ACS-GMØØ3-1 | |
| Name: HB4 | Verdeca HB4 Soybean |
| Code: IND-ØØ41Ø-5 | |
| Name: HB4 × GTS 40-3-2 | not available |
| Code: IND-ØØ41Ø-5 × MON-Ø4Ø32-6 | |
| Name: MON87701 | not available |
| Code: MON-877Ø1-2 | |
| Name: MON87701 × MON89788 | Intacta ™ Roundup Ready ™ 2 Pro |
| Code: MON-877Ø1-2 × MON-89788-1 | |
| Name: MON87705 | Vistive Gold ™ |
| Code: MON-877Ø5-6 | |
| Name: MON87705 × MON87708 × MON89788 | n/a |
| Code: MON-877Ø5-6 × MON-877Ø8-9 × MON-89788-1 | |
| Name: MON87705 × MON89788 | not available |
| Code: MON-877Ø5-6 × MON-89788-1 | |
| Name: MON87708 | Genuity ® Roundup Ready ™ 2 |
| Code: MON-877Ø8-9 | Xtend ™ |
| Name: MON87708 × MON89788 | not available |
| Code: MON-877Ø8-9 × MON-89788-1 | |
| Name: MON87708 × MON89788 × A5547-127 | not available |
| Code: MON-877Ø8-9 × MON-89788-1 × ACS-GMØØ6-4 | |
| Name: MON87712 | Not available |
| Code: MON-87712-4 | |
| Name: MON87751 | not available |
| Code: MON-87751-7 | |
| Name: MON87751 × MON87701 × MON87708 × MON89788 | not available |
| Code: MON-87751-7 × MON-877Ø1-2 × MON877Ø8 x | |
| MON89788 | |
| Name: MON87769 | not available |
| Code: MON87769-7 | |
| Name: MON87769 × MON89788 | not available |
| Code: MON-87769-7 × MON-89788-1 | |
| Name: MON89788 | Genuity ® Roundup Ready 2 Yield ™ |
| Code: MON-89788-1 | |
| Name: SYHTOH2 | Herbicide-tolerant Soybean line |
| Code: SYN-ØØØH2-5 | |
| Name: W62 | Liberty Link ™ soybean |
| Code: ACS-GMØØ2-9 | |
| Name: W98 | Liberty Link ™ soybean |
| Code: ACS-GMØØ1-8 | |

Cotton - Gossypium hirsutum L.: 66 Events

| | |
|---|---|
| Name: 19-51a | not available |
| Code: DD-Ø1951A-7 | |
| Name: 281-24-236 | not available |
| Code: DAS-24236-5 | |
| Name: 281-24-236 × 3006-210-23 (MXB-13) | WideStrike ™ Cotton |
| Code: DAS-24236-5 × DAS-21Ø23-5 | |
| Name: 281-24-236 × 3006-210-23 × COT102 | not available |
| Code: DAS-24236-5 × DAS-21Ø23-5 × SYN-IR1Ø2-7 | |
| Name: 281-24-236 × 3006-210-23 × COT102 × 81910 | not available |
| Code: DAS-24236-5 × DAS-21Ø23-5 × SYN-IR1Ø2-7 × DAS- | |
| 81910-7 | |
| Name: 3006-210-23 | not available |
| Code: DAS-21Ø23-5 | |
| Name: 3006-210-23 × 281-24-236 × MON 1445 | WideStrike ™ Roundup Ready ™ |
| Code: DAS-21Ø23-5 × DAS-24236-5 × MON-Ø1445-2 | Cotton |
| Name: 3006-210-23 × 281-24-236 × MON88913 | Widestrike ™ Roundup Ready Flex ™ |
| Code: DAS-21Ø23-5 × DAS-24236-5 × MON-88913-8 | Cotton |
| Name: 3006-210-23 × 281-24-236 × MON88913 × COT102 | Widestrike ™ × Roundup Ready |
| Code: DAS-21Ø23-5 × DAS-24236-5 × MON-88913-8 × SYN- | Flex ™ × VIPCOT ™ Cotton |
| IR1Ø2-7 | |
| Name: 3006-210-23 × 281-24-236 × MON88913 × COT102 × | not available |
| 81910 | |
| Code: DAS-21Ø23-5 × DAS-24236-5 × MON-88913-8 × SYN- | |
| IR1Ø2-7 × DAS-81910-7 | |
| Name: 31707 | BXN ™ Plus Bollgard ™ Cotton |
| Code: not available | |
| Name: 31803 | BXN ™ Plus Bollgard ™ Cotton |
| Code: not available | |
| Name: 31807 × 31808 | not available |
| Code: not available | |
| Name: 31807 | BXN ™ Plus Bollgard ™ Cotton |
| Code: not available | |
| Name: 31808 | BXN ™ Plus Bollgard ™ Cotton |
| Code: not available | |
| Name: 42317 | BXN ™ Plus Bollgard ™ Cotton |
| Code: not available | |
| Name: 81910 | not available |
| Code: DAS-8191Ø-7 | |
| Name: BNLA-601 | not available |
| Code: not available | |
| Name: BXN10211 (10211) | BXN ™ Cotton |
| Code: BXN-1Ø211-9 | |
| Name: BXN10215 (10215) | BXN ™ Cotton |
| Code: BXN-1Ø215-4 | |
| Name: BXN10222 (10222) | BXN ™ Cotton |
| Code: BXN-1Ø222-2 | |
| Name: BXN10224 (10224) | BXN ™ Cotton |
| Code: BXN-1Ø224-4 | |
| Name: COT102 (IR102) | not available |
| Code: SYN-IR1Ø2-7 | |
| Name: COT102 × COT67B | VIPCOT ™ Cotton |
| Code: SYN-IR1Ø2-7 × SYN-IR67B-1 | |
| Name: COT102 × COT67B × MON88913 | VIPCOT ™ Roundup Ready Flex ™ |
| Code: SYN-IR1Ø2-7 × SYN-IR67B-1 × MON-88913-8 | Cotton |
| Name: COT102 × MON15985 | Bollgard ® III |
| Code: SYN-IR1Ø2-7 × MON-15985-7 | |
| Name: COT102 × MON15985 × MON88913 | Bollgard ® III × Roundup Ready ™ |
| Code: SYN-IR1Ø2-7 × MON-15985-7 × MON-88913-8 | Flex ™ |
| Name: COT102x MON15985 × MON88913 × MON88701 | n/a |
| Code: SYN-IR1Ø2-7 × MON-15985-7 × MON-88913-8 × MON | |
| 887Ø1-3 | |
| Name: COT67B (IR67B) | not available |
| Code: SYN-IR67B-1 | |
| Name: Event 1 | not available |
| Code: JKCH - 1050 | |
| Name: Event1 | JK 1 |
| Code: JKCH-1947 Bt | |
| Name: GFM Cry1A | not available |
| Code: GTL-GFM311-7 | |
| Name: GHB119 | not available |
| Code: BCS-GHØØ5-8 | |
| Name: GHB614 | GlyTol ™ |
| Code: BCS-GHØØ2-5 | |
| Name: GHB614 × LLCotton25 | GlyTol ™ Liberty Link ™ |
| Code: BCS-GHØØ2-5 × ACS-GHØØ1-3 | |
| Name: GHB614 × LLCotton25 × MON15985 | not available |
| Code: BCS-GHØØ2-5 × ACS-GHØØ1-3 × MON-15985-7 | |
| Name: GHB614 × T304-40 × GHB119 | Glytol ™ × Twinlink ™ |
| Code: BCS-GHØØ2-5 × BCS-GHØ04-7 × BCS-GHØØ5-8 | |
| Name: GHB614 × T304-40 × GHB119 × COT102 | GlyTol LibertyLink TwinLink ® Plus |
| Code: BCS-GHØØ2-5 × BCS-GHØØ4-7 × BCS-GHØØ5-8 × SYN- | |
| IR1Ø2-7 | |
| Name: GHB811 | not available |
| Code: BCS-GH811-4 | |
| Name: GHB811 × T304-40 × GHB119 × COT102 | not available |
| Code: BCS-GHB811-4 × BCS-GHØØ4-7 × BCS-GHØØ5-8 × SYN- | |
| IR1Ø2-7 | |
| Name: GK12 | not available |
| Code: not available | |
| Name: LLCotton25 | Fibermax ™ Liberty Link ™ |
| Code: ACS-GHØØ1-3 | |
| Name: LLCotton25 × MON15985 | Fibermax ™ Liberty Link ™ Bollgard |
| Code: ACS-GHØØ1-3 × MON-15985-7 | |
| Name: MLS 9124 | not available |
| Code: not available | |
| Name: MON1076 | Bollgard ™ Cotton |
| Code: MON-89924-2 | |
| Name: MON1445 | Roundup Ready ™ Cotton |
| Code: MON-Ø1445-2 | |
| Name: MON15985 | Bollgard II ™ Cotton |
| Code: MON-15985-7 | |
| Name: MON15985 × MON1445 | Roundup Ready ™ Bollgard II ™ |
| Code: MON-15985-7 × MON-Ø1445-2 | Cotton |
| Name: MON1698 | Roundup Ready ™ Cotton |
| Code: MON-89383-1 | |
| Name: MON531 | Bollgard ™ Cotton, Ingard ™ |
| Code: MON-ØØ531-6 | |
| Name: MON531 × MON1445 | Roundup Ready ™ Bollgard ™ Cotton |
| Code: MON-Ø531-6 × MON-Ø1445-2 | |
| Name: MON757 | Bollgard ™ Cotton |
| Code: MON-ØØ757-7 | |
| Name: MON88701 | not available |
| Code: MON 887Ø1-3 | |
| Name: MON88701 × MON88913 | not available |
| Code: MON 887Ø1-3 × MON-88913-8 | |
| Name: MON88701 × MON88913 × MON15985 | not available |
| Code: MON 887Ø1-3 × MON-88913-8 × MON-15985-7 | |
| Name: MON88702 | not available |
| Code: MON-887Ø2-4 | |
| Name: MON88913 | Roundup Ready ™ Flex ™ Cotton |
| Code: MON-88913-8 | |
| Name: MON88913 (pima cotton) | not available |
| Code: MON-88913-8 | |
| Name: MON88913 × MON15985 | Roundup Ready ™ Flex ™ Bollgard II ™ |
| Code: MON-88913-8 × MON-15985-7 | Cotton |
| Name: Ngwe Chi 6 Bt | Ngwe Chi 6 Bt |
| Code: not available | |
| Name: SGK321 | not available |
| Code: not available | |
| Name: T303-3 | not available |
| Code: BCS-GHØØ3-6 | |
| Name: T304-40 | not available |
| Code: BCS-GHØØ4-7 | |
| Name: T304-40 × GHB119 | TwinLink ™ Cotton |
| Code: BCS-GHØØ4-7 × BCS-GHØØ5-8 | |
| Name: T304-40 × GHB119 × COT102 | not available |
| Code: BCS-GHØØ4-7 × BCS-GHØØ5-8 × SYN-IR102-7 | |
| Name: TAM66274 | not available |
| Code: TAM-66274-5 | |

| | |
|---|---|
| Event Name and Code | Trade Name |

Wheat - Triticum aestivum: 2 Events

| | |
|---|---|
| Name: HB4 Wheat | HB4 Wheat |
| Code: IND-ØØ412-7 | |
| Name: MON71800 | Roundup Ready ™ wheat |
| Code: MON-718ØØ-3 | |

The pesticidal combination according to the invention can be used to control, limit or prevent pests from the Coleoptera order and/or from the Diptera order.

The Coleoptera order can be selected from Elateridae family (such as for example Agriotes spp., Ludius spp., Ctenicera spp., Selatosomus spp., Chyptohypnus spp., Hypnoidus spp., Limonius spp., Aeolus spp., Hadromorphus spp., Hypnoidus spp., Melanotus spp., Pheletes spp., Conoderus spp., Athous spp., Agrypnus spp., Agrypnus variabilis, Pheletes californicus, Ludius aeripennis tinctus, Ludius aeripennis destructor, Ctenicera destructor, Ctenicera aeripennis destructor, Selatosomus destructor, Selatosomus aeripennis destructor, Selatosomus aeripennis aeripennis, Chyptohypnus nocturnus bicolor, Cryptohypnus nocturnus (Eschscholtz), Hypnoidus nocturnus, Hypolithus bicolor, Limonius californicus, Aeolus mellillus, Agriotes mancus, Hadromorphus glaucus, Agriotes brevis, Agriotes rufipalpis, Agriotes proximus, Agriotes littigiosus, Agriotes criddlei, Agriotes lineatus, Agriotes obscurus, Agriotes sputator, Agriotes, sordidus, Agriotes ustulatus, Hypnoidus abbreviates, Limonius canus, Limonius pctoralis, Limonius infuscatus, Agriotes fuscicollis, Melanotus opacaicicollis leconte), Tenebrionidae family (such as for example Gonocephalum spp., Adelium spp., Pterohelaeus spp., Gonocephalum aequatoriale, G. bilineatum, G. carpentariae (northern false wireworm), G. contractum, G. depressum, G. dorsogranosum, G. elderi (vegetable beetle), G. hoffmannseggii, G. macleaya, G. misellum, G. patruele, G. pusillum, G. reticulatum, G. rusticum, G. seriatum, G. setulosum, G. simplex (dusty surface beetle), G. torridum, G. tuberculatum, G. walker, Adelium brevicorne, Pterohelaeus alternatus) Chrysomelidae family (such as for example Diabrotica spp., Leptinotarsa spp., Phyllotreta spp., Chaetocnema spp.), Scarabidae family (such as for example Phyllophaga spp., Cyclocephala spp., Popilia spp., Halotrichia spp.), Curculionidae family (such as for example Anthonomus spp., Sphenopherus spp., Otiorhynchus spp.), and Nitidulidae family (such as for example Meligethes spp.).

The Diptera order can be selected from Anthomyiidae family (such as for example Delia sp., Delia platura, Hylemia platura, Hylemia spp., Pegomyia spp., Pegomyia hyoscyami, Phorbia spp.)

The most preferred pest can be from the Elateridae family, such as for example Agriotes spp., Ludius spp., Ctenicera spp., Selatosomus spp., Chyptohypnus spp., Hypnoidus spp., Limonius spp., Aeolus spp., Hadromorphus spp., Hypnoidus spp., Melanotus spp., Pheletes spp., Conoderus spp., Athous spp., Agrypnus spp., Agrypnus variabilis, Pheletes californicus, Ludius aeripennis tinctus, Ludius aeripennis destructor, Ctenicera destructor, Ctenicera aeripennis destructor, Selatosomus destructor, Selatosomus aeripennis destructor, Selatosomus aeripennis aeripennis, Chyptohypnus nocturnus bicolor, Cryptohypnus nocturnus (Eschscholtz), Hypnoidus nocturnus, Hypolithus bicolor, Limonius californicus, Aeolus mellillus, Agriotes mancus, Hadromorphus glaucus, Agriotes brevis, Agriotes rufipalpis, Agriotes proximus, Agriotes littigiosus, Agriotes criddlei, Agriotes lineatus, Agriotes obscurus, Agriotes sputator, Agriotes, sordidus, Agriotes ustulatus, Hypnoidus abbreviates, Limonius canus, Limonius pctoralis, Limonius infuscatus, Agriotes fuscicollis, Melanotus opacaicicollis leconte.

The pesticidal combination may be used in unmodified form, but it is generally formulated into a composition in various ways using formulation adjuvants, such as carriers, solvents and surface-active substances. The formulations can be in various physical forms, for example, in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). Such formulations can either be used directly or diluted prior to use. The dilutions can be made, for example, with water, liquid fertilisers, micronutrients, biological organisms, oil or solvents.

The formulations can be prepared for example by mixing the active ingredients (I) and (II), and optionally (III), (IV), (V) and (VI), with formulation adjuvants in order to obtain compositions in the form of finely divided solids, granules, solutions, dispersions or emulsions. The active ingredient can also be formulated with other adjuvants, such as finely divided solids, mineral oils, oils of vegetable or animal origin, modified oils of vegetable or animal origin, organic solvents, water, surface-active substances or combinations thereof.

The active ingredient can also be contained in very fine microcapsules. Microcapsules contain the active ingredient in a porous carrier. This enables the active ingredient to be released into the environment in controlled amounts (for example, slow-release). Microcapsules usually have a diameter of from 0.1 to 500 microns. They contain the active ingredient in an amount of about from 25 to 95% by weight of the capsule weight. The active ingredient can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the compositions according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, N-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting agents or suspending agents or for other purposes. Typical surface-active substances include, for example, salts of alkyl sulfates, such as diethanolammonium lauryl sulfate; salts of alkylarylsulfonates, such as calcium dodecyl-benzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters; and also further substances described e.g. in McCutcheon's Detergents and Emulsifiers Annual, MC Publishing Corp., Ridgewood New Jersey (1981).

Further adjuvants that can be used in pesticidal formulations include crystallisation inhibitors, viscosity modifiers, suspending agents, dyes, anti-oxidants, foaming agents, light absorbers, mixing auxiliaries, antifoams, complexing agents, neutralising or pH-modifying substances and buffers, corrosion inhibitors, fragrances, wetting agents, take-up enhancers, micronutrients, plasticisers, glidants, lubricants, dispersants, thickeners, antifreezes, microbicides, and liquid and solid fertilisers.

The formulations or compositions according to the invention can include an additive comprising an oil of vegetable or animal origin, a mineral oil, alkyl esters of such oils or mixtures of such oils and oil derivatives. The amount of oil additive in the composition according to the invention is generally from 0.01 to 10%, based on the active ingredient to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C₈-C₂₂ fatty acids, especially the methyl derivatives of C₁₂-C₁₈ fatty acids, for example the methyl esters of lauric acid, palmitic acid and oleic acid (methyl laurate, methyl palmitate and methyl oleate, respectively). Many oil derivatives are known from the Compendium of Herbicide Adjuvants, 10^{th} Edition, Southern Illinois University, 2010.

The formulation or compositions generally comprise from 0.1 to 99% by weight, especially from 0.1 to 95% by weight, of the active ingredients of the present invention and from 1 to 99.9% by weight of a formulation adjuvant which preferably includes from 0 to 25% by weight of a surface-active substance. Whereas commercial products may preferably be formulated as concentrates, the end user will normally employ dilute formulations.

Preferred formulations can have the following compositions (weight %):

### Emulsifiable Concentrates:

| | |
|---|---|
| Emulsifiable concentrates: | |
| active ingredient(s): | 1 to 95%, preferably 60 to 90% |
| surface-active agent(s): | 1 to 30%, preferably 5 to 20% |
| liquid carrier(s): | 1 to 80%, preferably 1 to 35% |
| Dusts: | |
| active ingredient(s): | 0.1 to 10%, preferably 0.1 to 5% |
| solid carrier(s): | 99.9 to 90%, preferably 99.9 to 99% |
| Suspension concentrates: | |
| active ingredient(s): | 5 to 75%, preferably 10 to 50% |
| water: | 94 to 24%, preferably 88 to 30% |
| surface-active agent(s): | 1 to 40%, preferably 2 to 30% |
| Wettable powders: | |
| active ingredient(s): | 0.5 to 90%, preferably 1 to 80% |
| surface-active agent(s): | 0.5 to 20%, preferably 1 to 15% |
| solid carrier(s): | 5 to 95%, preferably 15 to 90% |
| Granules: | |
| active ingredient(s): | 0.1 to 30%, preferably 0.1 to 15% |
| solid carrier(s): | 99.5 to 70%, preferably 97 to 85% |

The following Examples further illustrate, but do not limit, the invention.

| Wettable powders | a) | b) | c) |
|---|---|---|---|
| active ingredient(s) | 25% | 50% | 75% |
| sodium lignosulfonate | 5% | 5% | — |
| sodium lauryl sulfate | 3% | — | 5% |
| sodium diisobutylnaphthalenesulfonate | — | 6% | 10% |
| phenol polyethylene glycol ether (7-8 mol of | — | 2% | — |
| ethylene oxide) | | | |
| highly dispersed silicic acid | 5% | 10% | 10% |
| Kaolin | 62% | 27% | — |

The combination is thoroughly mixed with the adjuvants and the mixture is thoroughly ground in a suitable mill, affording wettable powders that can be diluted with water to give suspensions of the desired concentration.

| Powders for dry seed treatment | a) | b) | c) |
|---|---|---|---|
| active ingredient(s) | 25% | 50% | 75% |
| light mineral oil | 5% | 5% | 5% |
| highly dispersed silicic acid | 5% | 5% | — |
| Kaolin | 65% | 40% | — |
| Talcum | — | | 20 |

The combination is thoroughly mixed with the adjuvants and the mixture is thoroughly ground in a suitable mill, affording powders that can be used directly for seed treatment.

| Emulsifiable concentrate | |
|---|---|
| active ingredient(s) | 10% |
| octylphenol polyethylene glycol ether | 3% |
| (4-5 mol of ethylene oxide) | |
| calcium dodecylbenzenesulfonate | 3% |
| castor oil polyglycol ether (35 mol | 4% |
| of ethylene oxide) | |
| Cyclohexanone | 30% |
| xylene mixture | 50% |

Emulsions of any required dilution, which can be used in plant protection, can be obtained from this concentrate by dilution with water.

| Dusts | a) | b) | c) |
|---|---|---|---|
| active ingredient(s) | 5% | 6% | 4% |
| Talcum | 95% | — | — |
| Kaolin | — | 94% | — |
| mineral filler(s) | — | — | 96% |

Ready-for-use dusts are obtained by mixing the combination with the carrier and grinding the mixture in a suitable mill. Such powders can also be used for dry dressings for seed.

| Extruder granules | |
|---|---|
| active ingredient(s) | 15% |
| sodium lignosulfonate | 2% |
| carboxymethylcellulose | 1% |
| Kaolin | 82% |

The combination is mixed and ground with the adjuvants, and the mixture is moistened with water. The mixture is extruded and then dried in a stream of air.

| Coated granules | |
|---|---|
| active ingredient(s) | 8% |
| polyethylene glycol (mol. wt. 200) | 3% |
| Kaolin | 89% |

The finely ground combination is uniformly applied, in a mixer, to the kaolin moistened with polyethylene glycol. Non-dusty coated granules are obtained in this manner.

### Suspension Concentrate

| | |
|---|---|
| active ingredient(s) | 40% |
| propylene glycol | 10% |
| nonylphenol polyethylene glycol ether | 6% |
| (15 mol of ethylene oxide) | |
| Sodium lignosulfonate | 10% |
| carboxymethylcellulose | 1% |
| silicone oil (in the form of a 75% | 1% |
| emulsion in water) | |
| Water | 32% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

### Flowable Concentrate for Seed Treatment

| | |
|---|---|
| active ingredient(s) | 40% |
| propylene glycol | 5% |
| copolymer butanol PO/EO | 2% |
| Tristyrenephenole with 10-20 moles EO | 2% |
| 1,2-benzisothiazolin-3-one (in the form | 0.5% |
| of a 20% solution in water) | |
| monoazo-pigment calcium salt | 5% |
| Silicone oil (in the form of a 75% | 0.2% |
| emulsion in water) | |
| Water | 45.3% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

### Slow Release Capsule Suspension

28 parts of the active ingredient(s) of the invention are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed. The obtained capsule suspension is stabilized by adding 0.25 parts of a thickener and 3 parts of a dispersing agent. The capsule suspension formulation contains 28% of the active ingredient. The medium capsule diameter is 8-15 microns. The resulting formulation is applied to seeds as an aqueous suspension in an apparatus suitable for that purpose.

The amount of an active ingredient to be applied, will depend on various factors, such as the subject of the treatment, such as, for example plants, soil or seeds; the type of treatment, such as, for example spraying, dusting or seed dressing; the purpose of the treatment, such as, for example prophylactic or therapeutic; or the application time.

Suitably, the pesticidal combination according to the present invention can be applied at seeding as a seed or soil treatment.

Normally, in the management of a crop a grower would use one or more other agronomic chemicals in addition to the active ingredients of the present invention. Examples of agronomic chemicals include pesticides, such as acaricides, bactericides, fungicides, herbicides, insecticides, nematicides, as well as plant nutrients and plant fertilizers. Accordingly, the present invention also provides for the use of a pesticidal combination together with one or more further pesticides, plant nutrients or plant fertilizers. The combination may also encompass specific plant traits incorporated into the plant using any means, for example conventional breeding or genetic modification.

Suitable examples of plant nutrients or plant fertilizers are calcium sulfate (CaSO₄), calcium nitrate (Ca(NO₃)₂·4H₂O), calcium carbonate (CaCO₃), potassium nitrate (KNO₃), magnesium sulfate (MgSO₄), potassium hydrogen phosphate (KH₂PO₄), manganese sulfate (MnSO₄), copper sulfate (CuSO₄), zinc sulfate (ZnSO₄), nickel chloride (NiCl₂), cobalt sulfate (CoSO₄), potassium hydroxide (KOH), sodium chloride (NaCl), boric acid (H₃BO₃) and metal salts thereof (Na₂MoO₄). The nutrients may be present in an amount of 5% to 50% by weight, preferably of 10% to 25% by weight or of 15% to 20% by weight each. Preferred additional nutrients are urea ((NH₂)₂CO), melamine (C₃H₆N₆), potassium oxide (K₂O), and inorganic nitrates. The most preferred additional plant nutrient is potassium oxide. Where the preferred additional nutrient is urea, it is present in an amount of generally 1% to 20% by weight, preferably 2% to 10% by weight or of 3% to 7% by weight.

The pesticidal combination according to the present invention may also be used in combination with one or more of the following crop enhancement compounds:

Plant growth regulators including: abscisic acid, aminoethoxyvinyl glyine, ancymidol, butralin, carbaryl, chlormequat, chlorphonium, chlorpropham, cyclanilide, daminozide, dikegulac, dimethipin, ethephon, flumetralin, flurprimidol, fluoridamid, forchlorfenuron, fosamine, gibberellic acid, glyphosine, isopyrimol, jasmonic acid, maleic hydrazide, mefluidide, mepiquat, methylcyclopropene, paclobutrazol, piproctanyl, prohexadione, prohexadione-calcium, prohydrojasmon, propham, tetcyclacis, thidiazuron, tributyl phosphorotrithioate, tiaojiean, trinexapac, trinexapac-ethyl, 2,3,5-tri-iodobenzoic acid, uniconzole.

Plant activators including: acibenzolar, acibenzolar-S-methyl, chitosan, probenazole, Reynoutria sachalinensis extract, tiadinil.

Plant hormones including: abscisic acid (ABA), auxins (4-CPA, 2,4-D, 2,4-DB, 2,4-DEP, dichlorprop, fenoprop, indole-3-acetic acid (IAA), indole-3-butyric acid (IBA), 1-naphthaleneacetic acid (NAA), 1-naphthol, tryptophan), brassinosteroids, cytokinins (1,3-diphenyl urea, 2iP, 4-hydroxyphenethyl alcohol, adenine, benzyladenine, kinetin, thidiazuron, zeatin), ethylene, ethylene inhibitors (1-methylcyclopropene, aviglycine), ethylene releasers (ACC, etacelasil, ethephon, glyoxime), gibberellin (GA1, GA2, gibberellic acid GA3, GA4, GA5, GA6, GA7, GA8, GA9, GA10, GA11, GA12, GA13, GA14, GA15, GA16, GA17, GA18, GA19, GA20, GA21, GA22, GA23, GA24, GA25, GA26, GA27, GA28, GA29, GA30, GA31, GA32, GA33, GA34, GA35, GA36, GA37, GA38, GA39, GA40, GA41, GA42, GA43, GA44, GA45, GA46, GA47, GA48, GA49, GA50, GA51, GA52, GA53, GA54, GA55, GA56, GA57, GA58, GA59, GA60, GA61, GA62, GA63, GA64, GA65, GA66, GA67, GA68, GA69, GA70, GA71, GA72, GA73, GA74, GA75, GA76, GA77, GA78, GA79, GA80, GA81, GA82, GA83, GA84, GA85, GA86, GA87, GA88, GA89, GA90, GA91, GA92, GA93, GA94, GA95, GA96, GA97, GA98, GA99, GA100, GA101, GA102, GA103, GA104, GA105, GA106, GA107, GA108, GA109, GA110, GA111, GA112, GA113, GA114, GA115, GA116, GA117, GA118, GA119, GA120, GA121, GA122, GA123, GA124, GA125, GA126, GA127, GA128, GA129, GA130, GA131, GA132, GA133, GA134, GA135, GA136), jasmonates (jasmonic acid, methyl jasmonate), salicylates (salicylic acid), strigolactones (GR24, strigol, strigyl acetate, orobanchol, orobanchyl acetate, deoxystrigol, sorgolactone).

Defoliants including: calcium cyanamide, dimethipin, endothal, ethephon, merphos, metoxuron, pentachlorophenol, thidiazuron, tribufos.

Nutrition adapters including: fertilisers (nitrogen, phosphorous, potassium), macronutrients (calcium, magnesium, sulfur), micronutrients (boron, copper, iron, chloride, manganese, molybdenum, zinc), non-essential nutrients (cobalt, silicon, nickel), amino acids (Isabion®, Quantis®, Hyt®), iron chelate (Sequestrene®), nitrogen fixing bacteria (Rhizobium), phosphorous solubilizing bacteria (Penicillium bilaii (JumpStart®)).

Other crop enhancement compounds including: growth stimulators (24-epi brassinolide, 28-homobrassinolide, brassinolide, brassinolide-ethyl, DCPTA, forchlorfenuron, hymexazol, prosuler, pyripropanol, triacontanol), karrikins (KAR1, KAR2, KAR3, KAR4), lipo-chitooliogosaccharides, polyamines, unclassified plant growth regulators (2,4,5-T, 2-hydrazinoethanol, bachmedesh, benzofluor, buminafos, carvone, chlorfluren, chlorflurenol, choline chloride, ciobutide, clofencet, clofibric acid, cloprop, cloxyfonac, cyanamide, cyclanilide, cycloheximide, cyprosulfamide, dichlorflurenol, dimexano, epocholeone, ethylchlozate, fenridazon, flurenol, fuphenthiourea, furalane, heptopargil, hexafluoroacetone trihydrate, holosulf, inabenfide, isoprothiolane, karetazan, lead arsenate, MCPB, methasulfocarb, pydanon, sintofen, tecnazene, triapenthenol).

According to the present invention, the active ingredient(s) can be advantageously in the form of a soluble concentrate (SL), or a flowable concentrate for seed treatment (FS), or a suspension concentrate (SC), and can be more preferably a seed treatment slurry to be applied onto seeds. Slurries for seed treatment applications are well-known in the art. For example, a slurry can contain the active ingredient(s), in the form of a commercially available product or not, mixed with water and optionally with at least one polymer as described in the present invention, to optimize adhesion around the plant propagation material.

Each active ingredient can be applied to the plant propagation material from different compositions respectively, or the active ingredients can be gathered in the same composition (ready-mix composition). The composition may contain from about 0.001% to about 99% by weight of the active ingredient(s) over the total weight of the composition. Suitably, the composition contains from about 0.001% to about 50% by weight active ingredient(s) over the total weight of the composition. More suitably, the composition contains from about 0.001% to about 10% by weight active ingredient(s) over the total weight of the composition. More suitably, the composition contains from about 0.001% to about 1% by weight active ingredient(s) over the total weight of the composition. If the formulation is in the form of a concentrate, requiring dilution with water before use, it will contain a higher amount of active ingredients than a composition that is ready to use without dilution.

The solid carrier can be a natural or synthetic solid material that is insoluble in water. This carrier is generally inert and acceptable in agriculture, especially on the treated seed or other propagation material. It can be chosen, for example, from clay, diatomaceous earth, natural or synthetic silicates, titanium dioxide, magnesium silicate, aluminum silicate, talc, pyrophyllite clay, silica, attapulgite clay, kieselguhr, chalk, limestone, calcium carbonate, calcium montmorillonite, bentonite clay, Fuller's earth, cottonseed husks, wheat flour, soybean flour, pumice, wood flour, ground walnut shells, lignin, and the like.

Accordingly, the active ingredient(s) of the invention, and more preferably the composition(s) comprising the active ingredient(s), can preferably adhere to the propagation material, such as a seed.

Although it is believed that the present method can be applied to a seed in any physiological state, it is preferred that the seed be in a sufficiently durable state that it incurs no damage during the treatment process. Typically, the seed would be a seed that had been harvested from the field; removed from the plant; and separated from any cob, stalk, outer husk, and surrounding pulp or other non-seed plant material. The seed would preferably also be biologically stable to the extent that the treatment would cause no biological damage to the seed. It is believed that the treatment can be applied to the seed at any time between harvest of the seed and sowing of the seed or during the sowing process (seed directed applications).

The combination according to the present invention can be called a dressing composition, which relates to a liquid composition useful for covering and/or wetting a plant propagation material, and more preferably a seed, at least in part or in totality.

The combination according to the present invention is particularly suited for dressing applications on plant propagation material, especially on seeds.

The techniques of seed treatment application are well known to those skilled in the art, and they may be used readily in the context of the present invention.

The combination according to the present invention can be applied to seeds using conventional treating techniques and machines, such as fluidized bed techniques, the roller mill method, rotostatic seed treaters, and drum coaters. Other methods, such as spouted beds may also be useful. The seeds may be pre-sized before coating. After coating, the seeds are typically dried and then transferred to a sizing machine for sizing. Such procedures are known in the art and are set out in more detail below.

The combination of the invention can be applied to the seed as slurry or a soak. There also may be mentioned, e.g., film coating or encapsulation. The coating processes are well known in the art, and employ, for seeds, the techniques of film coating or encapsulation, or for the other multiplication products, the techniques of immersion. More particularly, the treatment could vary from a thin film of the formulation containing the composition of the invention on a plant propagation material, such as a seed, where the original size and/or shape are recognizable to a thick film (such as a coating or pelleting with many layers of different materials (such as carriers, for example, clays; different formulations, such as of active ingredients; polymers; and colourants)) where the original shape and/or size of the seed is no longer recognisable.

One method of applying the composition according to the invention consists in spraying or wetting the plant propagation material with the aqueous liquid preparation, or mixing the plant material with such liquid preparation. Also, before the application, the composition of the invention may be diluted with water by simple mixing at ambient temperature in order to prepare an on-farm seed treatment formulation.

Typically, a tank-mix formulation for seed treatment application comprises 0.25% to 80% by weight, especially 1 to 75% by weight, of active ingredient(s), and 99.75% to 20% by weight, especially 99% to 25% by weight, of a solid or liquid auxiliary (including, for example, a solvent such as water), where the auxiliaries can be a surfactant in an amount of 0 to 40% by weight, especially 0.5 to 30% by weight, based on the total weight of the tank-mix formulation.

Typically, a pre-mix formulation for seed treatment application comprises 0.5 to 99.9% by weight, especially 1 to 95% by weight, of active ingredient(s), and 99.5 to 0.1% by weight, especially 99 to 5% by weight, of a solid or liquid adjuvant (including, for example, a solvent such as water), where the auxiliaries can be a surfactant in an amount of 0 to 50% by weight, especially 0.5 to 40% by weight, based on the total weight of the pre-mix formulation.

Whereas commercial products will preferably be formulated as concentrates (e.g., pre-mix composition (formulation)), the end user will normally employ dilute formulations (e.g., tank mix composition).

### EXAMPLES

The following non-limiting examples demonstrate the improved behaviour associated with a pesticidal combination according to the present invention.

A synergistic effect exists whenever the action of an active ingredient combination is greater than the sum of the actions of the individual components.
The action to be expected E for a given active ingredient combination obeys the so-called COLBY formula and can be calculated as follows (COLBY, S. R. “Calculating synergistic and antagonistic responses of herbicide combination”. Weeds, Vol. 15, pages 20-22; 1967):
ppm=milligrams of active ingredient per liter of spray mixture
X=% action by active ingredient A) using p ppm of active ingredient
Y=% action by active ingredient B) using q ppm of active ingredient.
   According to COLBY, the expected (additive) action of active ingredients A)+B) using p+q ppm of active ingredient is

$$E = X + Y - \frac{X \cdot Y}{100}$$

If the action actually observed (O) is greater than the expected action (E), then the action of the combination is super-additive, i.e. there is a synergistic effect. In mathematical terms, the synergism factor SF corresponds to O/E. In the case of purely complementary addition of activities (expected activity), said difference (O-E) is zero. A negative value of said difference (O-E) signals a loss of activity compared to the expected activity.

### Example A

The products used in the following examples are detailed below, wherein table 1 gathers the active ingredient amounts in the combinations of the examples 1 to 6:
the active ingredient mixture comprising difenoconazole, metalaxyl-M, fludioxonil and sedaxane, is commercialized by Syngenta under the tradename VIBRANCE© QUATTRO for seed treatment;
the active ingredient mixture comprising difenoconazole, metalaxyl-M, fludioxonil, thiamethoxam and sedaxane, is commercialized by Syngenta under the tradename CRUISER® VIBRANCE® QUATTRO for seed treatment; and
the isocycloseram active ingredient is based on a flowable concentrate formulation for seed treatment comprising 100 g of isocycloseram per liter. Said formulation has been prepared according to WO2022/128912, incorporated herein by reference.

TABLE 1

| | difenoconazole | metalaxyl-M | fludioxonil | sedaxane | thiamethoxam | isocycloseram |
|---|---|---|---|---|---|---|
| | (g of AI/100 | (g of AI/100 | (g of AI/100 | (g of AI/100 | (g of AI/100 | (g of AI/100 |
| Ex. | kg of seeds) | kg of seeds) | kg of seeds) | kg of seeds) | kg of seeds) | kg of seeds) |
| 1 | 12 | 3 | 2.5 | 5 | 0 | 0 |
| 2 | 12 | 3 | 2.5 | 5 | 20 | 0 |
| 3 | 12 | 3 | 2.5 | 5 | 0 | 2.5 |
| 4 | 12 | 3 | 2.5 | 5 | 20 | 2.5 |
| 5 | 12 | 3 | 2.5 | 5 | 0 | 7.5 |
| 6 | 12 | 3 | 2.5 | 5 | 20 | 7.5 |

### Description of the Experiments

A cereal field trial was carried out to evaluate the performance of the pesticide combination of the invention, to control Elateridae family (wireworms) in cereals. This field trial was conducted with wireworm pressure in using bait balls. Two weeks later, the bait balls were removed from the field and assessed for wireworm pressure. Most bait balls had more than 15 wireworms, indicating enough pressure to conduct the field trial. Spring wheat seeds were treated in a Hege seed treater in mixing a slurry (formulated products listed above) of the active ingredients as described in Table 1 with 25 ml of water was added per 1 kg of seeds.

The methodology to evaluate the efficiency of crop protection products in the field is based on plant assessment. It was assessed: the plant stand (number of plants/12 row meter), the percentage (%) of plant vigour (43 days after planting), and the yield at moment the crop is at fully ripe stage (harvest has happened).

The results are gathered in the below tables 2, 3 and 4, wherein the table 2 relates to the results of % of increment on plant stand at 43 days after application (planting) (DAP) and 28 days after emergence (DAE). The total number of plants was counted in 12 row meter of each plot.

The table 3 relates to the results of % plant vigor at 43 days after application and 28 days after emergence. Visually inspect all plots and assign a value of 100% to the plot with the highest level of plant vigor in each replicate. All plots within a replicate should be rated relative to the plot with the highest vigor rating. The rating scale should range from 100% for the plot with the highest rating to 0% for dead plants.

The table 4 relates to the yield (biomass production) in kilograms/ha. At the fully ripe crop stage, the plots were harvested, and the grain weighted and reported as kg/7.5 m² per each plot. The raw data was transformed into yield (kg/ha) considering the standard moisture of 14.5%.

TABLE 2

| | Plant stand (number of plants/12 row meter) - at 43 DAP / 28 DAE | | |
|---|---|---|---|
| | | | % Increment |
| | Average of 4 replicates - | % Increment | based on |
| | Number of plants / 12 | based on Ex. 1 | Ex. 1 |
| Ex. | row meter | (Observed) | (Expected) |
| 1 | 83 | 0 | |
| 2 | 87 | 5 | |
| 3 | 102 | 22 | |
| 4 | 113 | 36 | 26 |
| 5 | 117 | 40 | |
| 6 | 129 | 55 | 43 |

TABLE 3

% of plant vigor - at 43 DAP / 28 DAE

| | | | % Increment |
|---|---|---|---|
| | Average of 4 replicates - | % Increment | based on |
| | % plant vigour (visual | based on Ex.1 | Ex. 1 |
| Ex. | assessment) | (Observed) | (Expected) |
| 1 | 75 | 0 | |
| 2 | 75 | 0 | |
| 3 | 86 | 15 | |
| 4 | 90 | 20 | 15 |
| 5 | 85 | 13 | |
| 6 | 96 | 28 | 13 |

TABLE 4

Yield (kg/ha)

| | | | % Increment |
|---|---|---|---|
| | | % Increment | based on |
| | Average of 4 replicates - | based on Ex. 1 | Ex. 1 |
| Ex. | Yield (kg/ha) | (Observed) | (Expected) |
| 1 | 3977 | 0 | |
| 2 | 3979 | 0 | |
| 3 | 4557 | 15 | |
| 4 | 4628 | 16 | 15 |
| 5 | 4626 | 16 | |
| 6 | 4806 | 21 | 16 |

### Example B

The products used in the following examples are detailed below, wherein table 5 gathers the active ingredient amounts in the combinations of the examples 7 to 12:
the active ingredient mixture comprising difenoconazole and metalaxyl-M, is commercialized by Syngenta under the tradename DIVIDEND EXTREME® for seed treatment;
the pydiflumetofen active ingredient is based on a flowable concentrate formulation for seed treatment comprising 500 g of pydiflumetofen per liter, commercialized by Syngenta under the tradename SALTRO®;
the sedaxane active ingredient is based on a flowable concentrate formulation for seed treatment comprising 500 g of sedaxane per liter, commercialized by Syngenta under the tradename VIBRANCE®;
the picarbutrazox active ingredient is based on a flowable concentrate formulation for seed treatment comprising 400 g of picarbutrazox per liter, commercialized by Syngenta under the tradename VAYANTIS®;
the thiamethoxam active ingredient is based on a flowable concentrate formulation for seed treatment comprising 600 g of thiamethoxam per liter, commercialized by Syngenta under the tradename CRUISER®; and
the isocycloseram active ingredient insecticide is based on a flowable concentrate formulation for seed treatment comprising 400 g of isocycloseram per liter. Said formulation has been prepared according to WO2022/128912, incorporated herein by reference.

TABLE 5

| | difenoconazole | metalaxyl-M | pydiflumetofen | sedaxane | picarbutrazox | thiamethoxam | isocycloseram |
|---|---|---|---|---|---|---|---|
| | (g of AI/100 | (g of AI/100 | (g of AI/100 | (g of AI/100 | (g of AI/100 | (g of AI/100 | (g of AI/100 |
| Ex. | kg of seeds) | kg of seeds) | kg of seeds) | kg of seeds) | kg of seeds) | kg of seeds) | kg of seeds) |
| 7 | 12 | 3 | 10 | 2.5 | 1.25 | 0 | 0 |
| 8 | 12 | 3 | 10 | 2.5 | 1.25 | 52 | 0 |
| 9 | 12 | 3 | 10 | 2.5 | 1.25 | 0 | 2.5 |
| 10 | 12 | 3 | 10 | 2.5 | 1.25 | 0 | 5 |
| 11 | 12 | 3 | 10 | 2.5 | 1.25 | 52 | 2.5 |
| 12 | 12 | 3 | 10 | 2.5 | 1.25 | 52 | 5 |

### Description of the Experiments

A cereal field trial was carried out to evaluate the performance of the pesticide combination of the invention, to control Elateridae family (wireworms) in cereals. This field trial was conducted with wireworm pressure in using bait balls. Two weeks later, the bait balls were removed from the field and assessed for wireworm pressure. Most bait balls had more than 15 wireworms, indicating enough pressure to conduct the field trial. Spring wheat seeds were treated in a Hege seed treater in mixing a slurry (formulated products listed above) of the active ingredients as described in Table 5 with 20 ml of water was added per 1 kg of seeds.

The methodology to evaluate the efficiency of crop protection products in the field is based on plant assessment, such as the percentage (%) of plant vigour through canopy cover.

To determine the canopy cover, a CANOPEO smartphone application “www.canopeoapp.com” is used, in taking two images per plot- (two subsamples per plot), so that recording the % canopy cover for each subsample. Images are framed to include discrete/representative areas of the plot and only include the plot of interest. Images are taken from a consistent height (around 90 cm above the crop dossel) using a yardstick and at a consistent angle parallel to the ground (considering the crop rows in each plot) to help frame sides of image to get a consistent angle. Areas with weeds and/or volunteer plants (in this case other crops which are not spring wheat) are avoided.

The results are gathered in the below table 6, which relates to the results of % plant vigor at 43 days after application (DAP) and 35 days after emergence (DAE).

TABLE 6

% of plant vigor - at 43 DAP / 35 DAE

| | | % Increment | % Increment |
|---|---|---|---|
| | | based on Ex 7 | based on Ex 7 |
| Ex. | % plant vigor | (Observed) | (Expected) |
| 7 | 19.3 | 0 | |
| 8 | 26.5 | 37.2 | |
| 9 | 49.7 | 157.5 | |
| 10 | 26.4 | 36.8 | |
| 11 | 89.1 | 361.4 | 136.1 |
| 12 | 68.7 | 256 | 60.3 |

The present invention enhances crop protection effect, especially in improving at least the number of plants per row meter, the plant vigour, and/or the yield.

1. A method of enhancing a crop by applying to a plant propagation material or a plant growing locus, a pesticidal combination comprising at least isocycloseram as active ingredient and thiamethoxam as active ingredient, in any desired sequence or simultaneously.

2. The method according to claim 1, characterized in that the enhancement is an increased resistance to biotic stress factors, and more preferably an increased resistance to pressure from pests of the Coleoptera order, and preferably from pests of the Elateridae family.

3. The method according to claim 1, characterized in that the enhancement is an increased plant number per row meter.

4. The method according to claim 1, characterized in that the enhancement is an increased plant vigour.

5. The method according to claim 1, characterized in that the enhancement is an increased yield.

6. The method according to claim 1, characterized in that the combination further comprises difenoconazole as active ingredient.

7. The method according to claim 1, characterized in that the combination further comprises metalaxyl-M as active ingredient.

8. The method according to claim 1, characterized in that the combination further comprises fludioxonil as active ingredient.

9. The method according to claim 1, characterized in that the combination further comprises sedaxane as active ingredient.

10. The method according to claim 1, characterized in that the pesticidal combination is in the form of a soluble concentrate, or a flowable concentrate for seed treatment, or a suspension concentrate.

11. A pesticidal combination used to treat a plant propagation material, comprising, over 100 kg of plant propagation material, from 0.5 gram to 500 grams of isocycloseram and preferably 0.5 gram to 10 grams of isocycloseram, and from 10 gram to 500 grams of thiamethoxam and preferably from 10 gram to 50 grams of thiamethoxam, and optionally at least one further active ingredient selected from difenoconazole, metalaxyl-M, fludioxonil, and sedaxane.

12. (canceled)

13. (canceled)

14. A pesticidal combination comprising isocycloseram and thiamethoxam, and optionally at least one or several further active ingredients selected from metalaxyl M, sedaxane, difenoconazole, fludioxonil, picarbutrazox, pydiflumetofen, thiabendazole, ipconazole, cyclobutrifluram, and azoxystrobin.

15. The pesticidal combination according to claim 14, comprising isocycloseram, thiamethoxam, metalaxyl-M, sedaxane, difenoconazole, and fludioxonil.

16. A plant propagation material treated with a pesticidal combination as defined in any one of the claim 1.

17. The pesticidal combination according to claim 14, comprising isocycloseram, thiamethoxam, and fludioxonil, and optionally at least one or several active ingredients selected from difenoconazole, metalaxyl-M, and sedaxane.

18. The pesticidal combination according to claim 14, comprising isocycloseram, thiamethoxam, and metalaxyl-M, and optionally at least one or several further active ingredients selected from difenoconazole, fludioxonil and sedaxane.
